(19) United States
(12) Patent Application Publication
(10) Pub. No.: US 2023/0196306 A1
(43) Pub. Date: Jun. 22, 2023

(54) SYSTEM AND METHODS FOR SOURCING AND PROCESSING RECYCLABLE MATERIALS

(71) Applicant: Evtek Inc., Dix Hills, NY (US)

(72) Inventors: Jonah E. Saltzman, Brooklyn, NY (US); Martin L. Naro, Dix Hills, NY (US); Shazad Sadick, Franklin Square, NY (US)

(21) Appl. No.: 18/084,688

(22) Filed: Dec. 20, 2022

Related U.S. Application Data
(60) Provisional application No. 63/291,775, filed on Dec. 20, 2021.

(51) Int. Cl. G06Q 10/30

(52) U.S. Cl. CPC G06Q 10/30

(57) ABSTRACT

The present disclosure relates to systems and methods for sourcing and processing recyclable materials. Systems and methods of the present disclosure include a user creating an account such that data is stored associating that user to a specific account. A quantifiable amount of recyclable material is recycled and identified by the system to create data about that recyclable material and associate the data with the specific user account. The user account is allocated monetary and/or non-monetary rewards to incentivize recycling. Monetary and/or non-monetary rewards can be donated to charitable organizations and/or used to purchase goods through an ecommerce interface or transferred to external financial accounts.

### RELATED APPLICATIONS

This application claims priority to U.S. Provisional Patent Application Ser. No. 63/291,775, filed on Dec. 20, 2021, the entire disclosure of which is hereby expressly incorporated by reference.

### BACKGROUND

### Technical Field

The present disclosure relates generally to the field of recycling systems and methods. More specifically, the present disclosure relates to recycling systems and methods for sourcing and processing recyclable materials.

### Related Art

It is common practice to dispose of high-quality waste materials that could otherwise be recycled, resulting in hundreds of billions of dollars in lost value and allowing billions of tons of carbon dioxide (“CO₂”) emissions to needlessly enter the atmosphere annually. Recycling and redemption centers benefit from high-quality materials, fast processing times, and system scalability, while consumers benefit from environmental insights, monetary incentives, and other rewards for their recycling actions. However, currently available recycling/waste management systems suffer due to material contamination at up to 85% of households, slow processing times, and poor scalability. Furthermore, currently available systems do not provide incentives to individuals, businesses, and other entities to pre-sort their recyclables and do not provide avenues for connecting these entities with recycling centers in need of high-quality recyclable material. Accordingly, individuals, businesses, and other entities producing high-quality recyclable waste material have little, or no, incentive to recycle their waste material in such a way that retains maximum value for these entities.

Thus, in view of the existing technology in this field, what would be desirable is a scalable system with minimized recyclable material processing time and which also incentivizes individuals and businesses to recycle their high-quality recyclable materials. Accordingly, the systems and methods disclosed herein solve these and other needs.

### SUMMARY

The present disclosure relates to systems and methods for sourcing and processing recyclable materials. According to embodiments of the present disclosure a recycling system includes a controller, a communications interface, a user interface device configured to receive user identification information, a housing having a first aperture for receiving recyclable material, and an identification system configured to identify the recyclable material. The controller retrieves a user account via the communications interface based on the user identification information, assigns a value to identified recyclable material, and associates the value with the user account. The value assigned by the controller can be a monetary value and the controller associates the monetary value with the user account. The system can also include a printer configured to generate a receipt with the value assigned to the identified recyclable material. The identification system can be an AI vision system configured to identify one or more of a material and a type of the recyclable material and can identify an ID tag on a primary containment unit containing recyclable material. The controller can also associate the ID tag with the user account. The recycling system can also include a conveyor system configured to transport the recyclable material from the first aperture to a containment unit.

According to some embodiments of the present disclosure, the controller monitors an amount of processed recyclable material and communicates the amount of processed material to a web-based server via the communications interface.

According to further embodiments of the present disclosure, the housing is configured to be moved from a first location to a second location via a transportation vehicle. According to such embodiments, the housing can be disposed within a trailer, the trailer including a hitch for coupling the trailer to the transportation vehicle.

According to still further embodiments of the present disclosure, the recycling system includes a second aperture configured to receive a primary containment unit and the first aperture is configured to receive individual items of recyclable material. A containment unit of the recycling system can have a first area for storing one or more primary containment units and a second area for storing one or more individual items of recyclable material. According to other embodiments of the present disclosure, the identification system includes a sorting system configured to transport one or more individual items of recyclable material to a first storage unit and one or more primary containment units to a second containment unit.

According to another embodiment of the present disclosure a recycling system includes a hopper for receiving recyclable material, a vision system configured to identify one or more types of the recyclable material, one or more containment units corresponding to the one or more types of the recyclable material, a sorting system configured to place an item of recyclable material in one or more of the containment units corresponding to an identified type of the item of recyclable material, and a conveyor system configured to transport the recyclable material from the hopper to the sorting system. The system can also include a return conveyor system for transporting unidentified recyclable material from the sorting system to the hopper for further processing.

According to some embodiments of the present disclosure, the sorting system includes one or more cartesian robotic sorters. According to other embodiments of the present disclosure, the sorting system includes one or more pneumatic sorting devices disposed along a length of the conveyor and configured to provide a stream of compressed air for removing the recyclable material from the conveyor system.

According to further embodiments of the present disclosure, the sorting system includes a guide configured to divert the recyclable material into one or more single profile conveyors of the conveyor system. A vision system can also be configured to identify contaminated items of the recyclable material and sorting system configured to place a contaminated item of recyclable material in one or more containment units corresponding to contaminated material.

A method for recycling according to the present disclosure includes receiving user identification information from a user interface device, receiving recyclable material, processing the recyclable material with a vision system, identifying a type of the recyclable material, assigning a monetary value to the recyclable material based on the identified type of the recyclable material, transmitting the user identification information and the monetary value of the recyclable material to a web-based server via a communications interface; identifying a user account associated with user identification information; and associating the monetary value of the recyclable material with the user account.

### BRIEF DESCRIPTION OF THE DRAWINGS

The foregoing features of the invention will be apparent from the following Detailed Description of the Invention, taken in connection with the accompanying drawings, in which:

FIG. 1. is a block diagram illustrating a recycling system of the present disclosure;

FIG. 2 is a perspective view of a containment system according to the present disclosure;

FIG. 3 is a perspective view of the containment system of FIG. 2, illustrating internal components thereof;

FIG. 4 is a perspective view of another containment system according to the present disclosure;

FIG. 5 is a perspective view of the containment system of FIG. 4, illustrating internal components thereof;

FIG. 6A is a front perspective view of another containment system according to the present disclosure;

FIG. 6B is a rear perspective view of the containment system of FIG. 6A;

FIG. 6C is diagram illustrating internal components of the containment system of FIG. 6A, with a hopper positioned in a closed configuration;

FIG. 6D is diagram illustrating the internal components of the containment system of FIG. 6A, with the hopper positioned in an open configuration;

FIG. 6E is a partial front perspective view of the containment system of FIG. 6A, illustrating internal components thereof;

FIG. 6F is a partial rear perspective view of the containment system of FIG. 6A, illustrating internal components thereof;

FIG. 7A is a front perspective view of a modular containment system according to the present disclosure;

FIG. 7B is an exploded view of the modular containment system of FIG. 7A;

FIG. 8 is a front perspective view of another modular containment system according to the present disclosure.

FIG. 9A is a front elevational view of another containment system according to the present disclosure;

FIG. 9B is a front perspective view of the containment system of FIG. 9A, positioned in an open configuration;

FIG. 10A is a partial front perspective view of another containment system according to the present disclosure;

FIG. 10B is an exploded view of the containment system of FIG. 10A;

FIG. 11A is a front perspective view of another modular containment system according to the present disclosure;

FIG. 11B is a diagram showing internal components of the modular containment system of FIG. 11A;

FIG. 12A is a rear perspective view of a mobile processing system according to the present disclosure, positioned in a closed configuration;

FIG. 12B is a rear perspective view of the mobile processing system of FIG. 12A, positioned in a deployed configuration;

FIG. 12C is a front perspective view of the mobile processing system of FIG. 12A, positioned in the deployed configuration;

FIG. 13 is a diagram of a primary containment unit having an ID tag according to the present disclosure;

FIG. 14 is a perspective view of another containment unit according to the present disclosure;

FIG. 15 is a diagram illustrating overall processing steps carried out by the system of the present disclosure;

FIG. 16A is a front perspective view of a processing system according to the present disclosure;

FIG. 16B is a rear perspective view of the processing system of FIG. 16A;

FIG. 17A is a front perspective view of another processing system according to the present disclosure;

FIG. 17B is a partial perspective view of the processing system of FIG. 17A;

FIG. 18A is a rear perspective view of another processing system according to the present disclosure;

FIG. 18B is a top view of the processing system of FIG. 18A;

FIG. 19A is a partial perspective view of a belt conveyor according to the present disclosure;

FIG. 19B is a front view of the belt conveyor of FIG. 19A;

FIG. 20A is a graphical user interface home page generated by the system of the present disclosure;

FIG. 20B is a graphical user interface wallet page generated by the system of the present disclosure;

FIG. 20C is a graphical user interface recycle page generated by the system of the present disclosure;

FIG. 20D is a graphical user interface progress page generated by the system of the present disclosure; and

FIG. 20E is a graphical user interface shop page generated by the system of the present disclosure.

### DETAILED DESCRIPTION

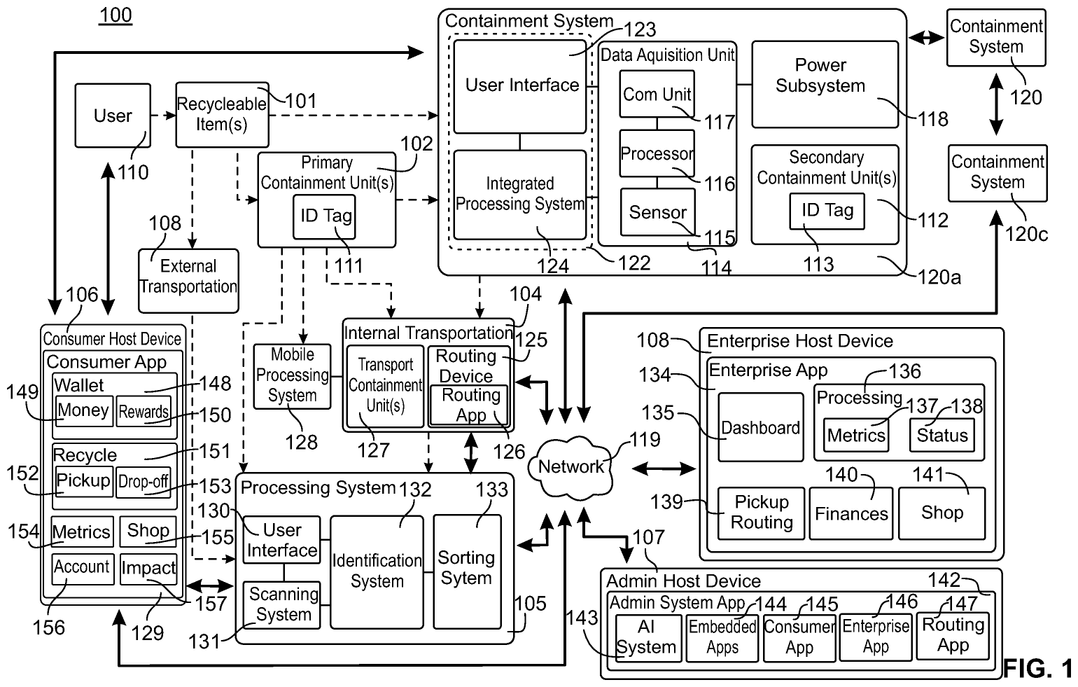

The present disclosure relates to systems and methods for sourcing and processing recyclable materials, as described in detail below in connection with FIGS. 1-20E.

FIG. 1. is a block diagram illustrating an example of a system 100 for recycling recyclable material. The system 100 can include, but is not limited to, recyclable material 101, one or more primary containment units 102, one or more containment systems 120a-c (together, “containment systems 120”), one or more internal transportation systems 104, one or more processing systems 105, one or more consumer host devices 106, one or more admin host devices 107, and one or more enterprise host devices 108. Dashed lines with arrows show possible process flows of the recyclable material 101 according to embodiments of the system 100. Solid lines with arrows show possible process flows of data and information being sent and received between the components of the system 100 according to embodiments of the present disclosure.

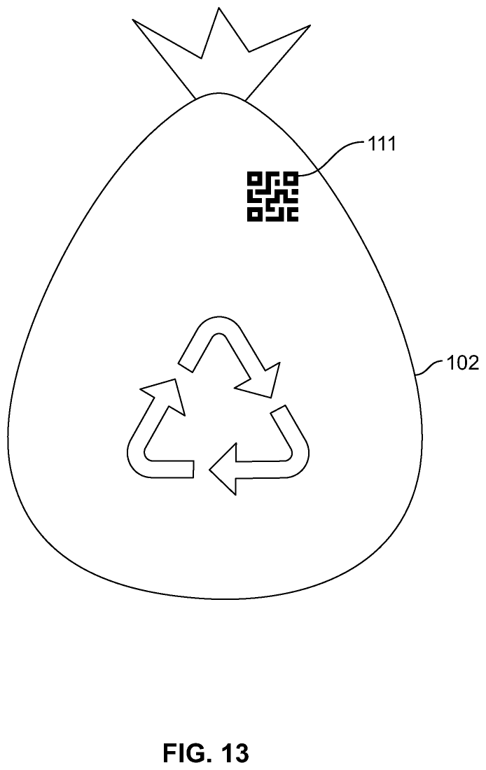

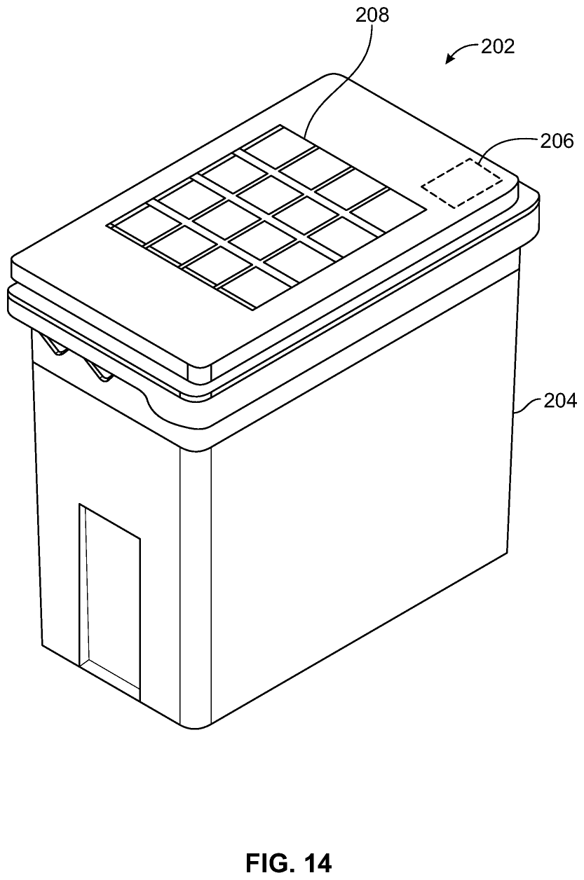

As shown, the recyclable material 101 may initially be placed by a user 110 in a primary containment unit 102, a containment system 120, or can be transported by the user 110 using external transportation 109. The recyclable material 101 may constitute any type or combination of recyclable items or materials, including, but not limited to, paper, e-waste, food and beverage containers composed of plastic/aluminum/glass or other materials, and/or clothing or textiles. External transportation 109 may include any form or combination of transportation not directly part of, or in communication with, system 100, such as, but not limited to, a personal vehicle, a public vehicle, or walking. A primary containment unit 102 may include, but is not limited to, a recycling bin, a recycling bag (e.g., as shown in FIG. 13), or any other hard-sided, soft-sided, or flexible structure or membrane that can be used to contain the recyclable material 101. The primary containment unit 102 may also include a cage, crate, or enclosure that can contain the recyclable material 101 other items (e.g., as shown in FIG. 14).

The primary containment unit 102 may contain or be affixed with an ID tag 111 that facilitates tracking of the recyclable material 101. The ID tag 111 may constitute an identifier written, printed, or etched on or inside the containment unit 102, an adhesive sticker placed on or inside the containment unit 102, or a tag fixed to the containment unit 102. The ID tag 111 may also be contained within the wall or structure of the containment unit 102. The ID tag 111 may utilize different communication technologies such as RFID, NFC, QR Codes, Bar Codes, or other forms of encoded or unencoded identifiers. The ID tag 111 may be machine readable and contain or be programmed with additional information used to track the containment unit 102 and the entity that recycled the recyclable material 101 such as account information and other user details.

Recyclable material 101 and/or one or more primary containment units 102 may be contained within, or be received by, one or more secondary containment units 112 of the containment system 120. According to some embodiments of the present disclosure, a secondary containment unit 112 may be subdivided such that loose recyclable material 101 is contained in one location and primary containment units 102 are contained in a separate location. The secondary containment unit 112 may be removed from the containment system 120. As such, the secondary containment unit 112 may comprise an independent structure configured such that the secondary containment unit 112 may be transported to other locations without the containment system 120 and may be replaced with another secondary containment unit 112. The secondary containment unit 112 may also contain or be affixed with an ID tag 113 that facilitates tracking of the recyclable material 101, primary containment units 102, and/or secondary containment unit 112. It should be understood that the ID tag 113 can be substantially similar in form and/or function to the ID tag 111 discussed in connection with primary containment unit 102.

According to some embodiments of the present disclosure, containment system 120 may be a stationary unit that stays in one location for multiple weeks, months, or years. According to other embodiments of the present disclosure, containment system 120 may be a mobile unit that is easily relocated from one location to another. Containment system 120 may have multiple doors, windows or entrances that are identical and/or different in order to accept specific types of recyclable material 101 and/or primary containment units 102. Containment system 120 may be configured for use in one or more of terrestrial, subterrestrial, hybrid, or other environments or locations.

As shown in FIG. 1, the containment system 120 includes a data acquisition unit 114, that facilitates the collection process of recyclable material 101, primary containment units 102, and/or secondary containment units 112. The data acquisition unit 114 may contain one or more sensors 115 of different or identical types that are configured to determine various characteristics about the contents of containment system 120, such as, but not limited to, a number of items contained, a volume of items contained, a type of items contained, and other related characteristics. These characteristics may be time-stamped quantities. These sensors 115 may also collect data about the operational status of components within containment system 120 or the location of containment system 120. These sensors 115 may gather data through, or comprise, one or more sources, such as, but not limited to, cameras or vision systems, global positioning systems, and/or proximity measurements. Sensors 115 communicate with one or more processors 116 configured to process the data that is gathered. Processor 116 may also communicate with one or more communication units 117 (hereinafter, “com units 117”) that transmit the processed data to locations external to the containment system. As discussed in greater detail herein, the transmission of data about the contents of the containment system 120, for example, to an enterprise host device 108 via a network 119, facilitates the collection of the items (e.g., recyclable material 101 and primary containment units 102) contained within the containment system 120, such as by determining a specific time that the contents should be collected to avoid overflowing. Com units 117 may incorporate one or more communication technologies, such as, but not limited to, Wi-Fi, Bluetooth, LoRa, cellular LTE/4G/5G, NFC, and others.

Communication units 117 (hereinafter, “com units 117”) may communicate directly with a network 119 (e.g., LAN, WAN, the Internet, cellular, etc.). Com unit 117 may also communicate with similar communication units of other containment systems if the containment system 120 cannot connect to the network 119 or if the containment system 120 cannot communicate with the network 119. For example, the containment system 120a may communicate with containment system 120b, which may then communicate with containment system 120c, which may in turn, communicate with the network 119. This process can be extended to any number of containment units in a mesh network that extends the communication distance such that containment units can communicate with the network 119 even if direct communication to the network 119 due to distance or other factors is not possible.

Containment system 120 may receive power from a power subsystem 118 that provides power to all electrical components within the containment system 120. The power subsystem 118 may receive power from a single source or from multiple sources simultaneously, such as, but not limited to, an AC outlet, solar panels, or wireless induction from a charging device. Power subsystem 118 may also include one or more batteries to store power and may contain a charging circuit to facilitate the voltage and/or current requirements of the batteries and/or components requiring electricity.

Containment system 120 may include one or more additional subsystems 122, one of which may enable users to interact with the containment system 120 through a user interface 123. Additional subsystems 122 may also include an integrated processing system 124 that may read ID 111 and/or ID 113 and facilitate the processing, sorting, and/or identification of recyclable material 101 and/or primary containment units 102 through robotic or mechanical means, thereby enabling recyclable material 101 processed by the containment system 120 to be associated with a user account. According to embodiments of the present disclosure, processing system 124 may use cameras, vision systems, or other sensors to capture data that can be used to count and/or identify characteristics about the recyclable material 101. The processing system 124 may be able to sort items by commodity/material type (e.g., can, bottle, aluminum, plastic, glass, etc.) and/or by size, weight, manufacturer, brand, or other characteristics. User interface 123 may be independent of processing system 124 and one may not require the presence of the other for proper operation.

User interface 123 may display data to the user 110 through visual and/or auditory means, such as through a video screen and/or tone emitted from a speaker or buzzer. The data displayed to the user 110 may include the quantity of items within the containment system 120. For example, the user 110 may be alerted that they deposited recyclable material 101 and/or a primary containment unit 102 into the containment system 120 with a tone, recorded sound, blinking screen, or light. User interface 123 may also communicate with other subsystems such as the data acquisition unit 114 and/or the processing system 124. According to some embodiments of the present disclosure, the user interface 123 provides a rich user experience through a full featured kiosk style interaction that includes a touchscreen and/or keypad for inputting and/or accessing account and/or user information. User 110 may create an account through the user interface 123, utilizing software running on processor 116 and/or other internal processing computational devices. The user interface 123 can also enable the user 110 to login to, or otherwise access, their user account, thereby also enabling the system 100 to associate recyclable material 101 received by the containment system 120 to be associated with the account of the user 110. User interface 123 may also include an ATM system which enables cash to be withdrawn from a user account, provides cash upon receipt of recyclable material 101 or other transaction. According to some embodiments of the present disclosure, user interface 123 may also include a dispensing feature, which provides empty primary containment units 102 (e.g., recycling bags) to a user 110 for future collection of recyclable material 101. These empty primary containment unit 102 may be in a single-use or multi-use form. According to further embodiments of the present disclosure, user interface 123 may include a security feature, enabling a user 110 to unlock a door, window, or other entrance of the containment system 120, thereby providing for recyclable material 101 and/or primary containment units 102 to be securely placed into containment system 120.

The contents of containment system 120 may be transported via internal transportation 104 (e.g., a truck, trailer, or other vehicle in communication with system 100) to a processing system 105 or other location in system 100. For example, internal transportation 104 can include a transportation vehicle directly owned or operated by the system 100 owner or by secondary/tertiary partners. The internal transportation 104 may be an initial receiving location of the recyclable material 101, or it may receive and contain one or more primary containment units 102, or one or more secondary containment units 112 that were previously located in the containment system 120. The internal transportation 104 may also receive recyclable material 101 and or primary containment unit 102 directly from containment system 120, such that they may or may not be contained within a secondary containment unit 112.

Internal transportation 104 may be routed to specific locations via a routing device 125 with geolocation and positioning capabilities such as a global positioning system. Internal transportation 104 may comprise a vehicle controlled by a human operator or an automated vehicle that does not require a human operator or any hybrid human controlled/automated transportation system. Routing device 125 may comprise a mobile communication device such as a cellular smartphone device or be integrated directly into internal transportation 104, for example, to provide for automated driving capabilities. Routing device 125 can utilize a software routing application 126 that transmits routing points from the network 119 to internal transportation 104 and facilitates the transmission of real-time location data for additional route optimization back to network 119.

Routing application 126 enables driving routes to be generated and dynamically updated based on, for example, scheduled pickup times and locations requested by the user 110 via consumer host device 106 running a consumer application 129. Routing application 126 may also generate and dynamically update driving routes based on real-time capacity levels of one or more containment systems 120. Routing application 126 may also provide a preview of the number of stops, estimated distance, and estimated time of a given route. Routing application 126 may provide specific information, for example, locations of pickups and expected quantities of recyclable material 101 to be picked up, to a human operator/driver or automated driving system. Routing application 126 may enable a human operator/driver or automated system to associate an ID tag 111 and/or an ID tag 113 with a specific user account and verify if the ID tag 111 and/or ID tag 113 has been previously been associated with the specific user account. Routing application 126 may also provide data on items or products that are to be delivered at specific pickup and/or drop off locations.

Internal transportation 104 may contain one or more transport containment units 127 for transporting one or more of recyclable material 101, primary containment units 102, and/or secondary containment units 112 within the internal transportation 104. The transport containment unit 127 may comprise a recycling bin, a recycling bag, or any other hard-sided, soft-sided, or flexible structure or membrane that can contain the recyclable material 101, primary containment units 102, secondary containment units 112, and/or other items. The transport containment unit 127 may also comprise a cage, crate, or enclosure that can contain the recyclable material 101, primary containment units 102, secondary containment units 112, and/or other items. Internal transportation 104 may also include or be in communication with a mobile processing system 128.

According to embodiments of the present disclosure, the transport containment unit 127 may be affixed with an ID tag (not shown) that facilitates the tracking of its contents. The ID tag may be similar in form and function to ID tag 111 described herein and, as such, can comprise an identifier, written, printed, or etched, on or inside the transportation containment unit 127, an adhesive sticker placed on or inside the transportation containment unit(s) 127, or a tag fixed to the transportation containment unit 127. The ID tag may also be contained within the wall or structure of the transportation containment unit 127. The ID tag may utilize different communication technologies such as RFID, NFC, QR Codes, Bar Codes, or other forms of encoded or unencoded identifiers. According to some embodiments, the ID tag is machine readable and contains or is programmed with additional information used to track the transportation containment unit 127.

Mobile processing system 128 may read ID tag 111, ID tag 113, and the ID tag associated with the transportation containment units 127, and count and/or sort recyclable material 101, primary containment units 102, and/or secondary containment units 112 through robotic or mechanical means, thereby providing for the contents of any containment unit described herein to be associated with a user account. According to one example, the mobile processing system 128 may use cameras or other sensors to capture data that used to count and identify characteristics of the recyclable material 101. The mobile processing system 128 can also sort items by commodity/material type and/or by size, weight, manufacturer, brand, or other characteristics. Additionally, the mobile processing system 128 provides for items to be stored in one or more transportation containment units 127 after processing and may accept pre-processed items from one or more transportation containment units 127 before processing.

External transportation 109 may be the initial receiving location of the recyclable material 101, or it may receive and contain one or more primary containment units 102. External transportation 109 may also be utilized to transport recyclable material 101 or primary containment units 102 to the processing system 105.

Processing system 105 may receive one or more of recyclable material 101, the primary containment units 102, the secondary containment units 112, the transport containment units 127, or any combination of the aforementioned items or units. These items and units may be received from internal transportation 104, external transportation 109, a user 110 or from other sources in the system 100. According to embodiments of the present disclosure, the processing system 105 includes a user interface 130, a scanning system 131, an identification system 132, and a sorting system 133. Processing system 105 may communicate data and information with the consumer host device 106, the routing device 125, and other devices and subsystems in system 100 for example, via the network 119.

User interface 130 provides a rich user experience through a full featured kiosk style interaction that may include a touchscreen and/or keypad for inputting and/or accessing account and other user information. For example, the user 110 may create an account through user interface 130. Those of ordinary skill in the art will understand that the user interface 130 can comprise machine readable instructions stored on a memory and configured to be executed by a (e.g., general purpose) processor, a presentation device (e.g., display or monitor), and one or more input devices (e.g., a keyboard and mouse) for receiving input from a user 110. According to some embodiments of the present disclosure, the user interface 130 can comprise a touchscreen housed in a kiosk style device in communication with the processing system 105. According to other embodiments of the present disclosure, the user interface 130 can comprise a display of a consumer host device 106 of the user 110 in communication with the processing system 105. Similarly, the user interface 130 can comprise a display of the routing device 125 in communication with the processing system. Those of ordinary skill in the art will understand the user interface 130 can also be displayed on other external displays and/or devices in communication with the processing system 105, for convenience, multiuser use, and diagnostics. By utilizing user interface 130 and logging into their user account, a user 110 who inputs recyclable material 101 into the processing system 105, may associate those items with their user account. User interface 130 may communicate information to user 110 about the processing status of their recyclable material 101 and display information about these items. User interface 101 may also enable user 110 to initiate, momentarily pause, and/or complete processing of identification system 132 and/or sorting system 133.

Scanning system 131 provides for the scanning of ID tags 111 and/or 113 and/or other ID tags integrated on/in primary containment units 102, secondary containment units 112, and/or transportation containment units 127. One embodiment of scanning system 131 may comprise a handheld device that is capable of reading data from ID tag 111, ID tag 113 or other ID tags present in system 100. Scanning system 131 may utilize the scanning capabilities of the routing device 125, or other external devices that can communicate with processing system 105 utilizing, for example, network 119. Scanning system 131 may scan tags utilizing RFID, NFC, QR Codes, Bar Codes, or other forms of encoded or unencoded identifiers disclosed herein or otherwise known or developed. Scanning system 131 may communicate with the user interface 130, the identification system 132, and/or with the sorting system 133. After scanning an ID tag, the processing system 105 can remove the recyclable material 101 from the containment unit (e.g., primary containment unit 102, secondary containment unit 112, or transportation containment unit 127) that was containing the recyclable material 101. Removal from the containment unit may be accomplished through the use of sensors, robotics, and/or mechanical systems described herein or otherwise known or developed.

Identification system 132 utilizes cameras and/or other sensors and systems to capture data that can be used to count and identify characteristics about recyclable material 101. For example, the identification system 132 may utilize a conveyor system to transport recyclable material 101 past one or more cameras or other sensors. Identification system 132 may also utilize software algorithms (e.g., artificial intelligence, machine learning, and the like) to identify and differentiate various characteristics of the recyclable material 101. Identification system 132 may communicate data and information about recyclable material 101 to the sorting system 133. Identification system 132 may transport recyclable material 101 to sorting system 133 or may transport recyclable material 101 to an external containment unit.

Sorting system 133 may receive recyclable material 101 from identification system 132. Sorting system 133 may utilize robotic or mechanical subsystems to sort items by commodity/material type and/or by size, weight, manufacturer, brand, or other characteristics.

Enterprise host device 108 running software enterprise application 134 will enable an enterprise user to see a preview of various data and analytics on a dashboard 135. This data can be accessed further through individual pages such as a processing page 136, which may display information such as metrics data 137 and status data 138 related to one or more processing systems 105. According to one example, the metrics data 137 may include the number and type of recyclable material 101 processed by one or more specific processing systems 105 in a given period of time and the status data 138 may show the operating status of one or more specific processing systems 105, or components thereof, at the current time and over previous periods of time. Enterprise application 134 can also include pickup routing page 139 where an enterprise user can assign and send routes to one or more routing applications 126, which can be accessed by specific users with unique login credentials. Enterprise application 134 can also include a finances page 140, which can include financial information about the cumulative value of recyclable material 101 processed by one or more processing systems 105 and/or other components of system 100. The enterprise application 134 can also include a shop page 141, providing for the purchase of additional equipment and services. Additional features may be present in enterprise application 134. Those of ordinary skill in the art will understand that the enterprise application 134 can comprise machine readable instructions stored on a memory and configured to executed by a processor of the enterprise host device 108, which can include, but is not limited to, one or more of a general-purpose computer, a mobile computing system, a server, a web-server, or the like.

Admin host device 107 running administration software system application 142 (hereinafter, “admin application 142”) provides for a system administrator to orchestrate and control various subsystems of the system 100. For example, as described in further detail herein, using admin application 142, a system administrator can create, deploy, run, control, and test various software code related to an AI system 143, enabling operation of integrated processing system 124 and/or identification system 132, and/or optimizing other subsystems in processing system 105 or system 100. For example, according to embodiments of the present disclosure, one or more embedded applications 144 enable a system administrator to create, deploy, run, control, and test various software code in various parts of system 100, such as, but not limited to, containment system 120 and processing system 105. According to other embodiments of the present disclosure, a consumer application 145 enables a system administrator to create, deploy, run, control, and test various software code related to the consumer application 129. According to further embodiments of the present disclosure, an enterprise application 146 enables a system administrator to create, deploy, run, control, and test various software code related to the enterprise app 108. According to still further embodiments of the present disclosure, a routing application 147 enables a system administrator to create, deploy, run, control, and test various software code related to the routing application 126. Accordingly, those of ordinary skill in the art will understand that the admin host device 107 communicates through the network 119 to create, deploy, run, control, and test various software code on various parts of system 100. Those of ordinary skill in the art will also understand that the admin application 142 can comprise machine readable instructions stored on a memory and executed by a processor of the admin host device 107, which can include, but is not limited to, one or more of a general-purpose computer, a mobile computing system, a server, a web-server, or the like.

Consumer host device 106 running consumer application 129 provides features to facilitate recycling and access services provided by system 100. A user 110 may create an account utilizing the consumer application 129 running on the user device 106. According to some embodiments of the present disclosure, the consumer application 129 includes a plurality of pages, or graphical user interfaces. For example, a wallet 148 enables a user 110 to view, receive, and transact funds associated with the account of the user 110 to a bank account or other financial account. Monetary funds in the wallet 148 and/or money 149 may be granted to user 110 for recycling recyclable material 101 based, for example, on the value of each item of recyclable material 101 and/or the value of individual parts of the item. According to some embodiments of the present disclosure, the wallet 148 enables the user 110 to donate funds to a charitable organization listed in the consumer application 129. According to further embodiments of the present disclosure, rewards 150 provides a user with additional incentives to recycle, such as, for example, coupons, discounts, prizes, and other physical and/or digital assets. The rewards stored in the application section rewards 150 may be granted to the user 110 based on, for example, recycling a specific amount of recyclable material 101 or by satisfying other criteria. Application section recycle 151 enables user 110 to schedule a pickup utilizing a pickup graphical user interface or element 152 and to determine a drop-off location utilizing a drop-off graphical user interface or element 153. For example, the pickup graphical user interface or element 152 may provide a calendar with available dates that correspond to availability of internal transportation 104 in a specific geographic location. Pickup graphical user interface or element 152 may also enable the user 110 to specify the amount and type of recyclable material 101 that are to be picked up. According to still further embodiments of the present disclosure, a drop-off graphical user interface or element 153 provides an interactive map (e.g., Google Maps) showing drop-off locations and locations where users can utilize a processing system 105 or containment system 120. According to still further embodiments of the present disclosure, a metrics graphical user interface or element 154 provides information about the number, type, and size of recyclable material 101 that has been recycled by the user and associated with the account of the user 110. The metrics graphical user interface or element 154, or similar section of consumer application 129, may also enable the user 110 to earn badges based on their progress of recycling certain amounts of recyclable material 101, and enable the user 110 to compete against other users and wager application-based points (e.g., points associated with a monetary value that are awarded based on every item recycled). According to still further embodiments of the present disclosure, a shop graphical user interface or element 155 enables the user 110 to purchase primary containment units 102 and other materials and/or supplies utilized in the recycling process and/or sustainable goods utilizing an account balance, points, or monetary funds transferred from an external account (e.g., a bank account or credit card account). According to still further embodiments of the present disclosure, an account graphical user interface or element 156 allows the user 110 to upload a profile photo, change data or information associated with their account, and see details about previous transactions. An impact graphical user interface or element 157 enables the user 110 to see their carbon footprint based on the specific number, type, and size of items recycled. Those of ordinary skill in the art will understand that consumer device 106 may transmit and receive data to and from the network 119, one or more processing systems 105, and one or more of the containment systems 120, in addition to other subsystems or components of system 100 described herein. Those of ordinary skill in the art will also understand that the consumer application 145 can comprise machine readable instructions stored on a memory and executed by a processor of the consumer host device 106, which can include, but is not limited to, one or more of a general-purpose computer, a mobile computing system, a server, a web-server, or the like.

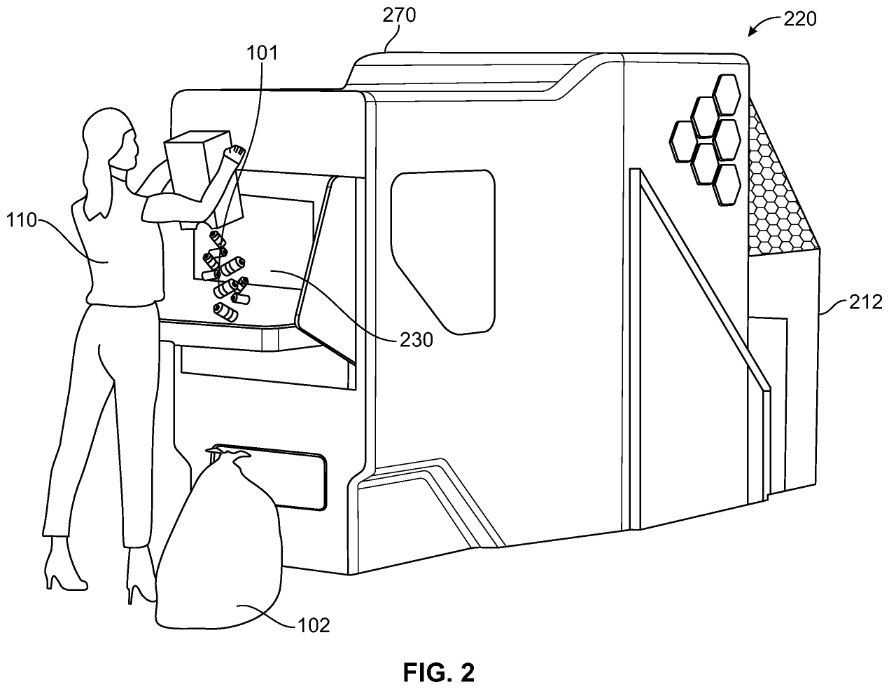

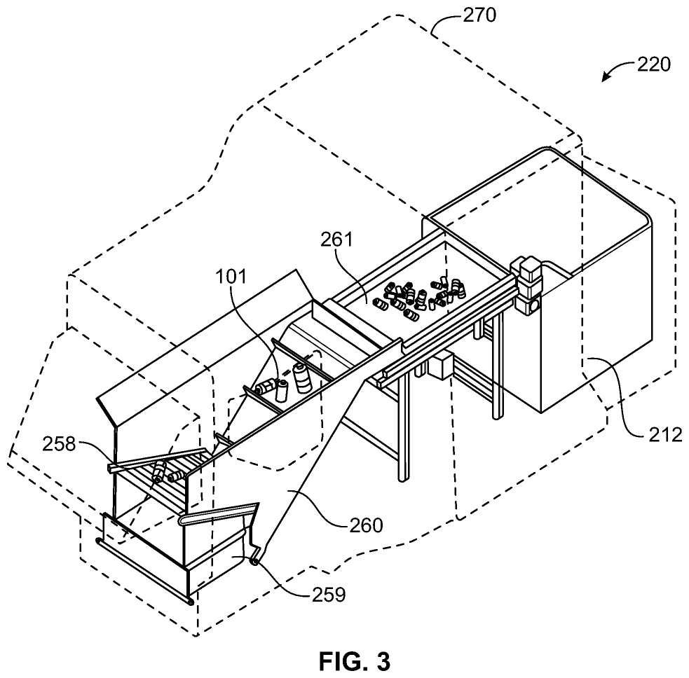

FIG. 2 is a perspective view of another embodiment of a containment system according to the present disclosure (hereinafter, “containment system 220”) and FIG. 3 is a perspective view of the containment system 220 illustrating internal components thereof. Containment system 220 can be substantially similar in function and structure to the containment system 120, discussed in connection with FIG. 1, except for distinctions noted herein, or otherwise apparent to persons of ordinary skill in the art. As shown in FIG. 2, the user 110 places recyclable material 101 into the containment system 220. A primary containment unit 102 (e.g., a recycling bag) is also shown containing additional recyclable items 101. A user interface 230 enclosed within a housing 270 of the containment system 220 enables the user 110 to interact with the containment system 220.

As shown in FIG. 3, a grizzly bar separator 258 is utilized to remove unwanted liquid and debris from recyclable material 101 and the unwanted liquid and debris is directed the into a debris vessel 259. An inclined conveyor 260 brings recyclable material 101 to a horizontal conveyor 261 so the recyclable material 101 can be identified with an identification system (e.g., identification system 132, described in connection with FIG. 1). After identification, the recyclable material 101 is deposited into a secondary containment unit 212.

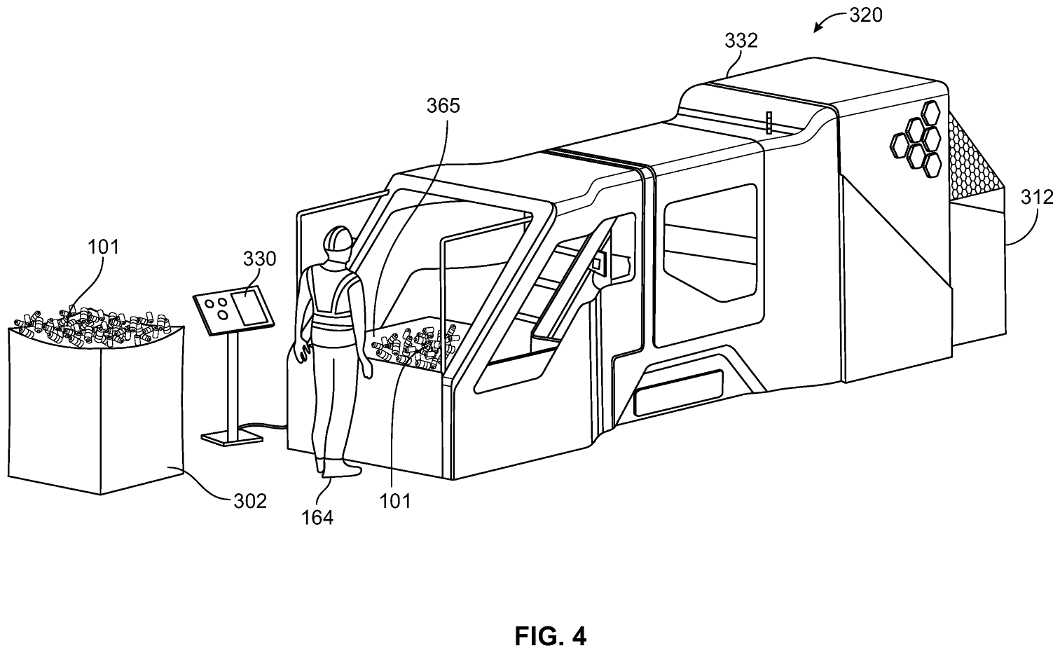

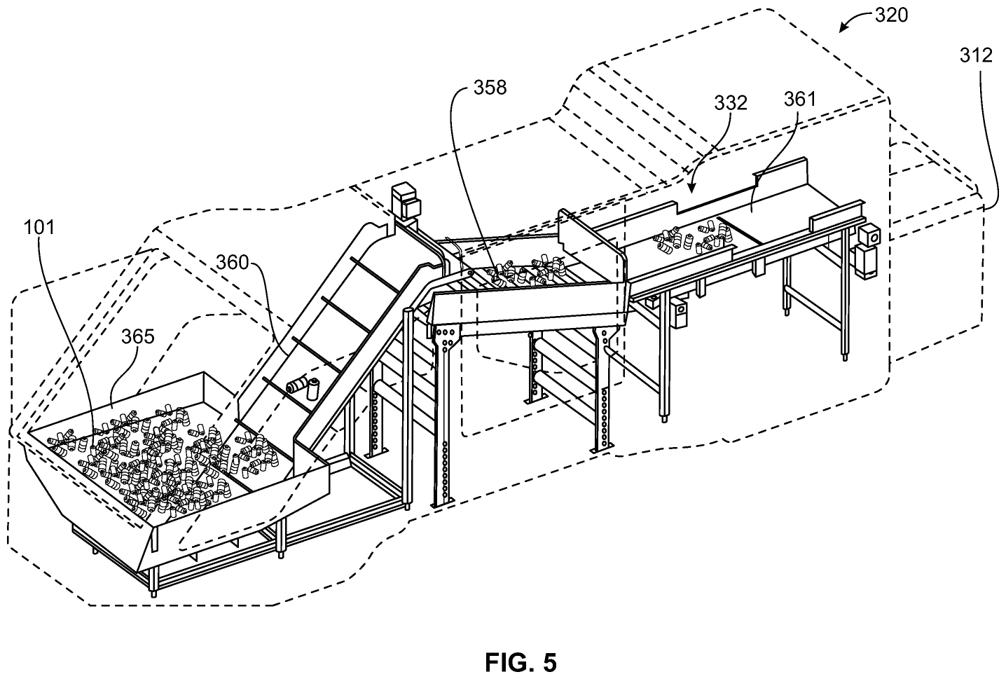

FIG. 4 is a perspective view of another embodiment of a containment system according to the present disclosure (hereinafter, “containment system 320”) and FIG. 5 is a perspective view of the containment system 320 illustrating internal components thereof. Containment system 320 can be substantially similar in function and structure to the containment system 120, discussed in connection with FIG. 1, except for distinctions noted herein, or otherwise apparent to persons of ordinary skill in the art. FIGS. 4 and 5 are referred to jointly herein. FIG. 4 also shows, another embodiment of a primary containment unit according to the present disclosure (hereinafter, “containment unit 302”) for storing recyclable material 101 prior to being processed by the containment system 320. A Machine Operator 164 utilizes a user interface 330 of the containment system 320 to control the containment system 320 and process the recyclable material 101.

The containment system 320 includes a hopper 365 configured to receive a plurality of individual items of recyclable material 101 for processing. An inclined conveyor 360 brings the recyclable material 101 to a grizzly bar separator 358 to remove unwanted liquid and debris from the recyclable material 101. A horizontal conveyor 361 transports recyclable material 101 through an identification system 332 (e.g., vision system) for identification. The identified recyclable material 101 is then deposited in a secondary containment unit 312 for storage and/or transportation.

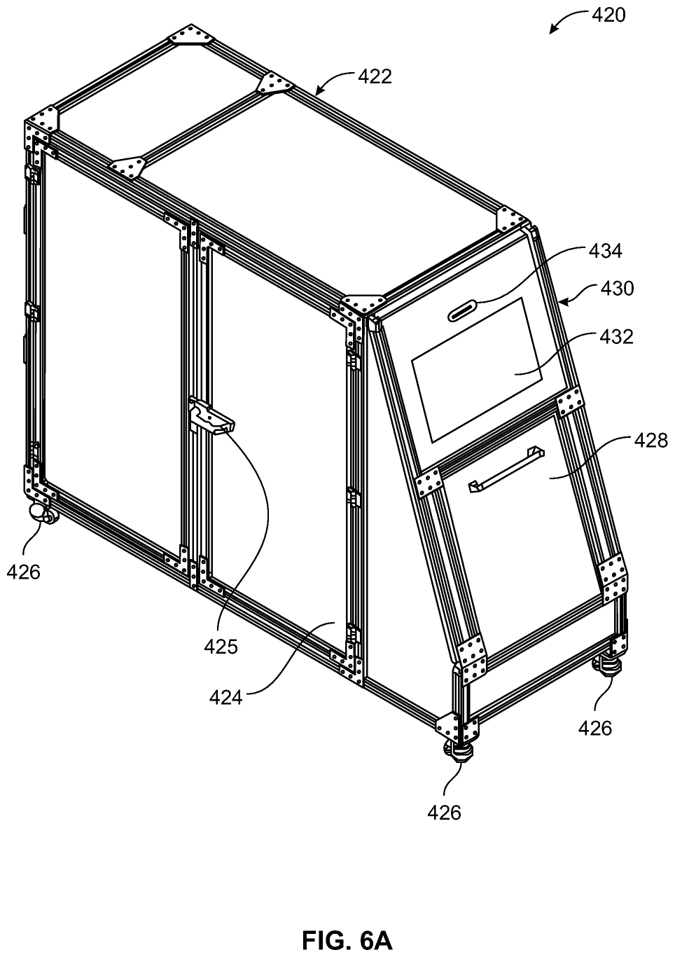

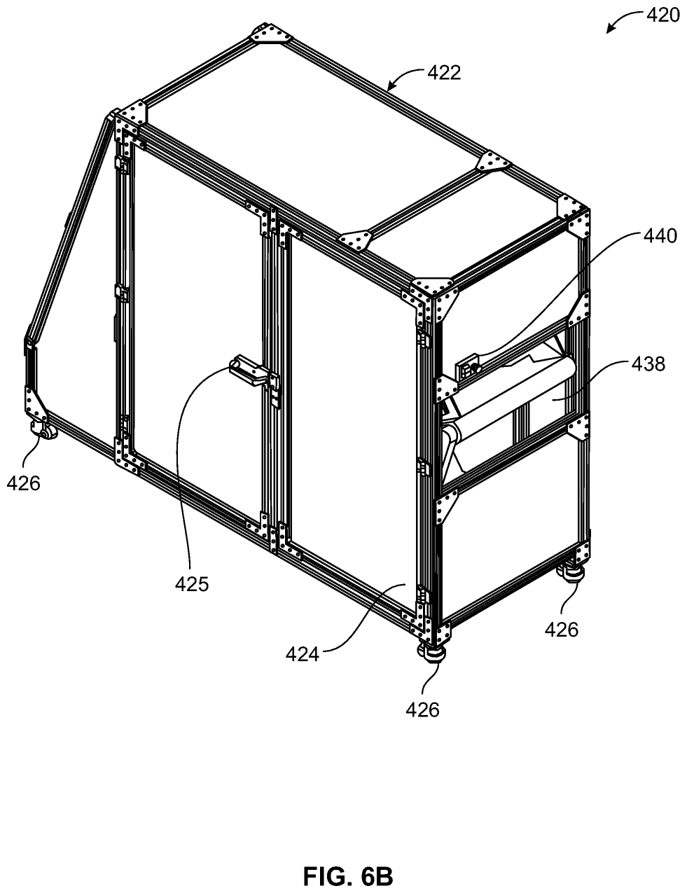

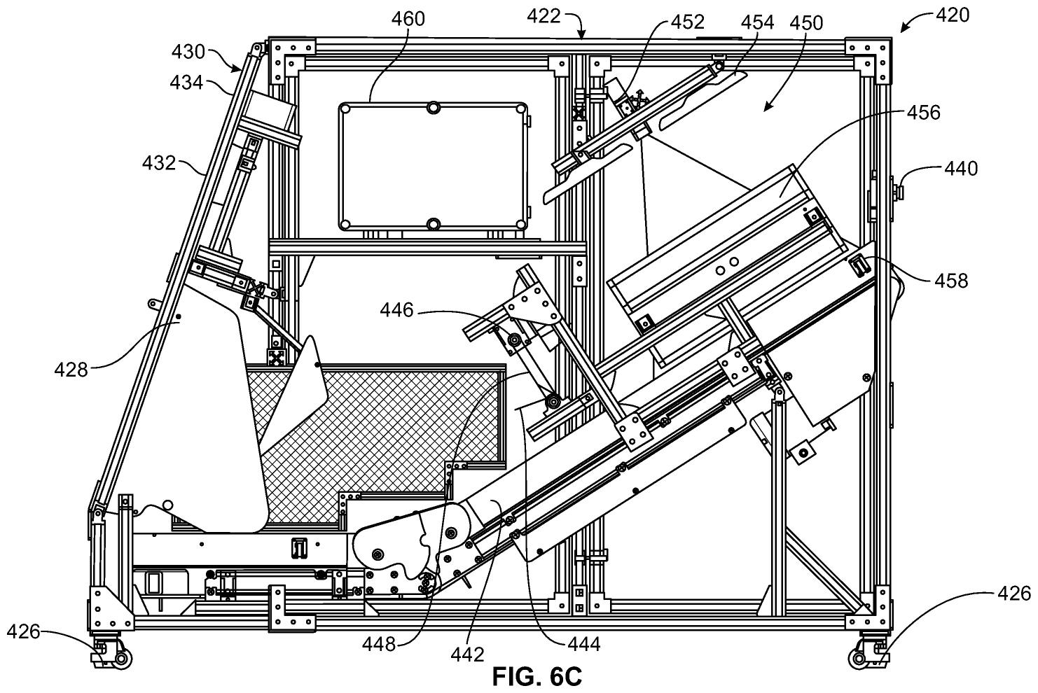

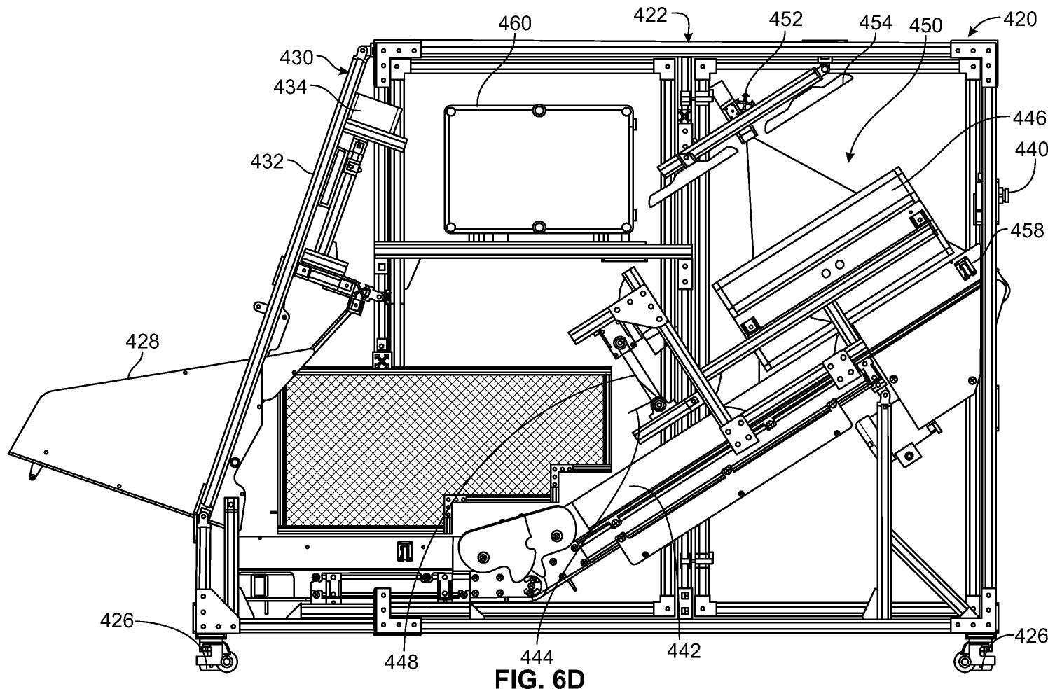

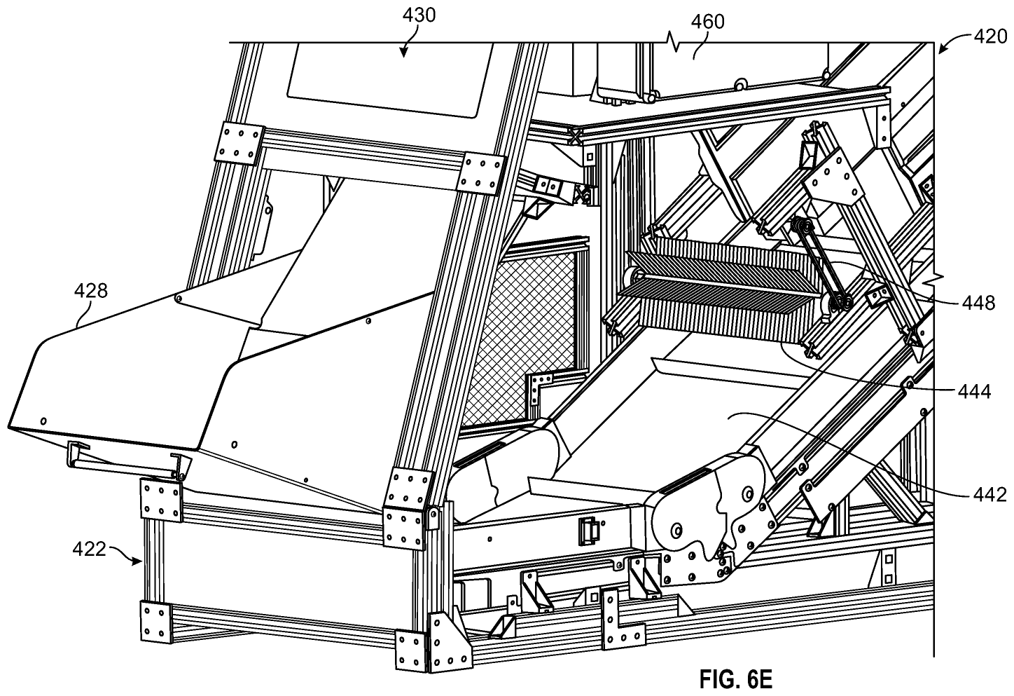

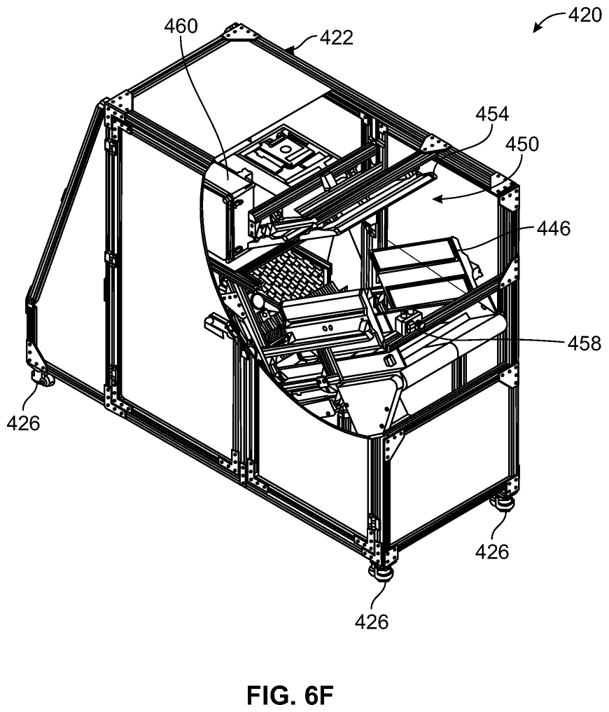

FIGS. 6A-F show another embodiment of a containment system according to the present disclosure (hereinafter, “containment system 420”). Specifically, FIG. 6A is a front perspective view of the containment system 420, FIG. 6B is a rear perspective view of the containment system 420, FIG. 6C is diagram illustrating internal components of the containment system 420, with a hopper 428 positioned in a closed configuration, FIG. 6D is diagram illustrating the internal components of the containment system 420, with the hopper 428 positioned in an open configuration, FIG. 6E is a partial front perspective view of the containment system 420 illustrating internal components thereof, and FIG. 6F is a partial rear perspective view of the containment system 420 illustrating internal components thereof. FIGS. 6A-F are referred to jointly herein. Containment system 420 can be substantially similar in function and structure to the containment system 120, discussed in connection with FIG. 1, except for distinctions noted herein, or otherwise apparent to persons of ordinary skill in the art.

Containment system 420 can include a housing 422, one or more access doors 424 with locking mechanisms 425 preventing and/or providing access to an interior of the containment system 420, casters 426 providing for ease of movement and/or leveling of the containment system 420, and a hopper 428 configured to receive one or more items of recyclable material 101 when positioned in an open configuration (e.g., as shown in FIGS. 6D and 6E). The containment system 420 also includes a user interface device 430, including a touchscreen display 432 and a receipt printer 434. As shown in FIG. 6B, the housing 422 includes an exit aperture 438 where recyclable material 101 exits the containment system 420. The exit aperture 438 is positioned such that the recyclable material 101 exiting the housing 422 drops into a secondary containment unit (e.g., containment unit 212, shown and described in connection with FIG. 3) positioned adjacent to the containment system 420. An e-stop and power control device 440 can be positioned on a rear side of the housing 422, such that an operator can interrupt power to the containment system 420 in the event of a system malfunction or error.

As shown best in FIG. 6E, an incline conveyor 422 transports the recyclable material 101 from the hopper 428 to a flapper strip 444 driven by a motor 446 and a drive belt 448. It should be understood that the flapper strip is configured and positioned to singulate the recyclable material 101 on the conveyor 442, such that individual items of the recyclable material 101 are physically separated and can be viewed and identified by a vision system 450. As shown, the vision system 450 includes one or more cameras 452 for capturing images of the recyclable material 101, and a top light 454 and side lights 456 configured to illuminate the recyclable material 101 from multiple angles such that the one or more cameras 452 of the vision system 450 can efficiently capture images of the recyclable material 101.

The containment system 420 can also include a conveyor beam sensor, or other sensor heretofore known and developed, configured to count individual items of recyclable material passing through the vision system 450, or otherwise monitoring the conveyor 442 for obstructions. According to some embodiments of the present disclosure, data from the sensor 458 can be used to verify the number of items of recyclable material 101 that have been identified by the vision system 450.

The containment system 420 can also include control electronics 460 in communication with one or more of the locking mechanisms 425, the user interface device 430, the receipt printer 434, the e-stop device, the incline conveyor 442, the flapper motor 446, the vision system 450 and/or other components, systems, or subsystems of the containment system 420 of the present disclosure. Those of ordinary skill in the art will understand that the control electronics 460 can comprise machine readable instructions stored on a memory and executed by a processor of containment system 420, including, but not limited to, one or more of a general-purpose processor, an application-specific integrated circuit (“ASIC”) device, a general-purpose computer, a mobile computing system, a server, a web-server, or the like. Furthermore, as described, for example, in connection with FIG. 1, the electronics 460 can include one or more communication interfaces, providing for two-way (e.g., direct, network, serial, etc.) communication between the containment system 420 and one or more of a consumer host device 106, an admin host device 107, an enterprise host device 108, a processing system 105, another containment system (e.g., containment systems 120, 220, 320 or otherwise disclosed herein), or other components or systems of the system 100 described herein.

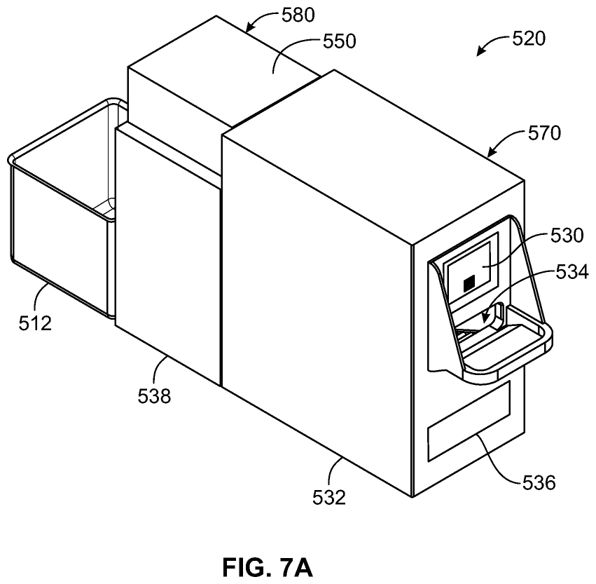

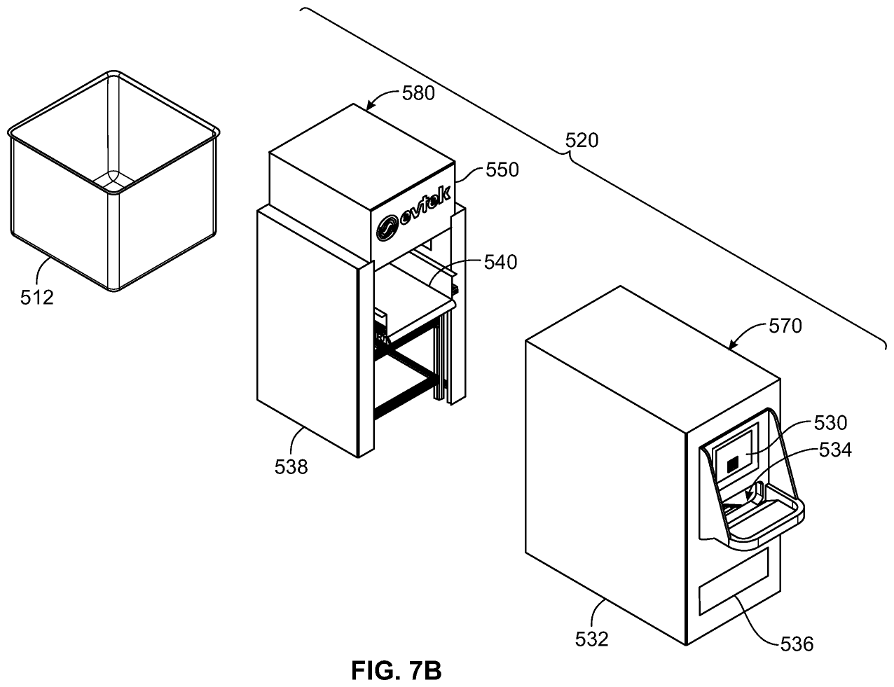

FIGS. 7A and 7B show an embodiment of a modular containment system according to the present disclosure (hereinafter, “containment system 520”). Specifically, FIG. 7A is a front perspective view of the containment system 520 and FIG. 7B is an exploded view illustrating modular components of the containment system 520. FIGS. 7A and 7B are referred to jointly herein. Containment system 520 can include similar functionality and structure to the containment system 420, discussed in connection with FIGS. 6A-F, except for distinctions noted herein, or otherwise apparent to persons of ordinary skill in the art.

Containment system 520 includes a vending system module 570, which can be releasably coupled to, and in communication with, a vision system module 580, and a secondary containment unit 512. The return vending module 570 includes a user interface device 530, a housing 532, an aperture disposed through the housing 532 and configured to receive one or more items of recyclable material 101, and a debris access hatch 536 disposed through the housing 532 and configured to provide access to a debris bin (e.g., debris bin 259, shown and described in connection with FIG. 3) located within the housing. According to embodiments of the present disclosure, the return vending module 570 can also include one or more components of the containment system 420, shown and described in connection with FIGS. 6A-F, such as, but not limited to, the incline conveyor 442, the flapper strip 444, and the control electronics 460.

The vision system module 580 includes a housing 538, a horizontal conveyor system 540, and a vision system 550. According to embodiments of the present disclosure, the vision system module 580 can also include one or more components of the containment system 420, shown and described in connection with FIGS. 6A-F, such as, but not limited to, the e-stop and or/power control device 440, the camera 452, the top light 454, the side lights 456, and the conveyor beam sensor 458.

Furthermore, as described, for example, in connection with FIG. 1, the containment system 520 can include one or more communication interfaces, providing for two-way (e.g., direct, network, serial, etc.) communication between the containment system 520 and one or more of a consumer host device 106, an admin host device 107, an enterprise host device 108, a processing system 105, another containment system (e.g., containment systems 120, 220, 320, etc. or otherwise disclosed herein), or other components or subsystems of the system 100.

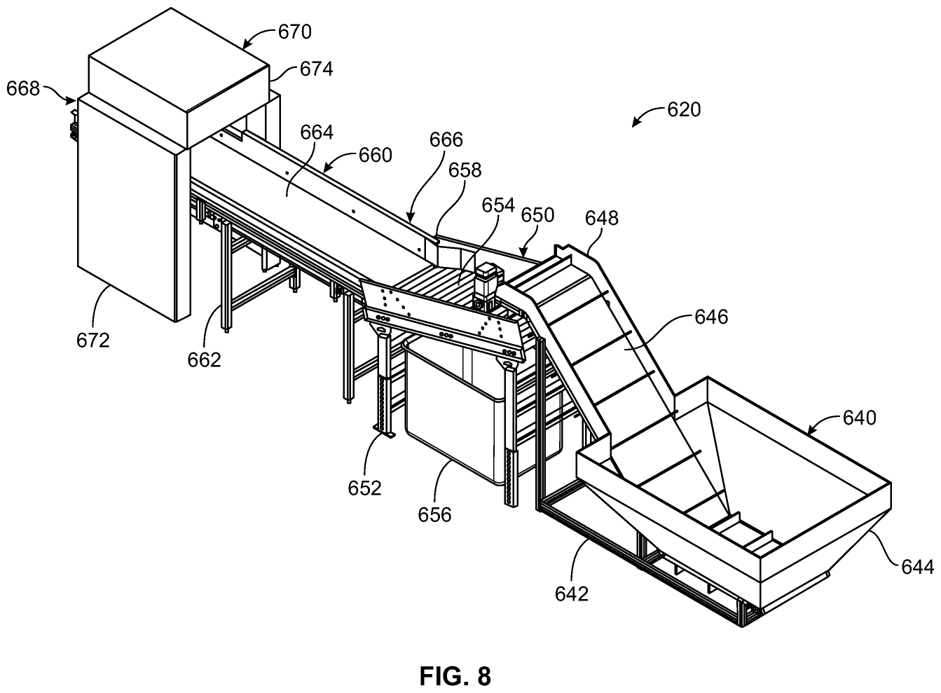

FIG. 8 shows an embodiment of a modular containment system according to the present disclosure (hereinafter, “containment system 620”). Specifically, FIG. 8 is a front perspective view of the containment system 620. Containment system 620 can include similar functionality and structure to the modular containment system 520, discussed in connection with FIGS. 7A and 7B, except for distinctions noted herein, or otherwise apparent to persons of ordinary skill in the art.

As shown, containment system 620 includes a hopper module 640, a debris collection module 650, a conveyor module 660, and a vision system module 670. According to embodiments of the present disclosure, the hopper module 640, the debris collection module 650, the conveyor module 660, and the vision system module 670 can be releasably coupled to, and in communication with, one or more of the other modules. According to other embodiments of the present disclosure, one or more of the hopper module 640, the debris collection module 650, the conveyor module 660, and the vision system module 670 can be configured as freestanding modules and can be operable independent of the other modules of the conveyor system 620.

As shown, the hopper module 640 includes a frame 642 supporting a hopper 644 and an incline conveyor 646. The hopper 644 is configured to receive one or more items of recyclable material 101 and the conveyor 646 is configured to move the recyclable material 101 from the hopper 644 to the debris collection module 650.

The debris collection module 650 includes a frame 652 supporting a grizzly bar separator 654. The frame 652 can be configured such that the grizzly bar separator 654 is positioned to receive (e.g., positioned under) recyclable material 101 from a distal end 648 of the incline conveyor 646. The grizzly bar separator 654 can disposed at an angle such that the recyclable material 101, e.g., by action of gravity, moves to a distal end 658 of the grizzly bar separator 654 adjacent to the conveyor module 660. A debris bin 656 can be positioned under the grizzly bar separator 654 to receive unwanted particulate, liquids, and other unwanted debris from the recyclable material 101.

The conveyor module 660 includes a frame 662 supporting a horizontal conveyor 664. The frame 652 can be configured such that a proximal end 666 of the conveyor 664 is substantially aligned with the distal end 658 of the grizzly bar separator 654, such that the conveyor 664 can receive recyclable material 101 therefrom. The conveyor 664 is configured to transport the recyclable material 101 from the proximal end 666 thereof to a distal end 668 thereof, which is positioned under and/or within the vision system module 670.

The vision system module 670 includes a housing 672 and a vision system 674. The vision system 674 can be substantially similar to the vision system 450, discussed in connection with containment system 420. As shown, the vision system module 670 can be configured to be positionable over the conveyor module 660, such that recyclable material 101 traveling from the proximal end 666 to the distal end 668 of the conveyor 664 can be identified by the vision system module 670 before being deposited into a secondary containment unit (not shown) positioned adjacent to the proximal end 668. According to embodiments of the present disclosure, the vision system module 670 can also include one or more components of the containment system 420, shown and described in connection with FIGS. 6A-F, such as, but not limited to, the e-stop and or/power control device 440, the camera 452, the top light 454, the side lights 456, and the conveyor beam sensor 458.

According to some embodiments of the present disclosure, the containment system 620 can also be provided with a user interface module (not shown), similar to the user interface 330 of the containment system 320, shown and described in connection with FIG. 3.

Furthermore, as described, for example, in connection with FIG. 1, the containment system 620 can include one or more communication interfaces, providing for two-way (e.g., direct, network, serial, etc.) communication between the containment system 620 and one or more of a consumer host device 106, an admin host device 107, an enterprise host device 108, a processing system 105, another containment system (e.g., containment systems 120, 220, 320, etc. or otherwise disclosed herein), or other components or subsystems of the system 100.

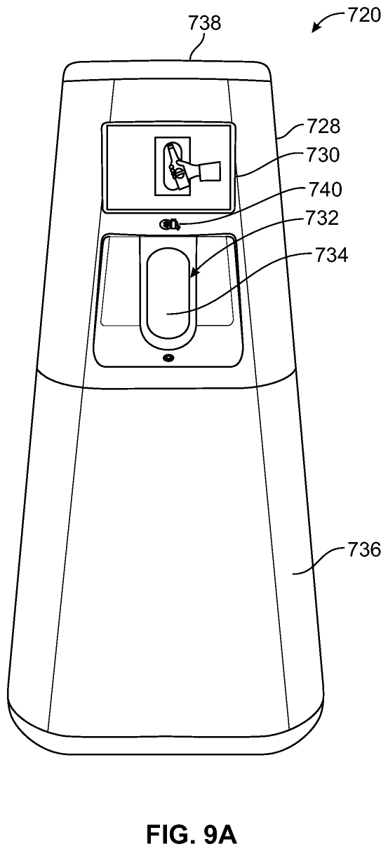

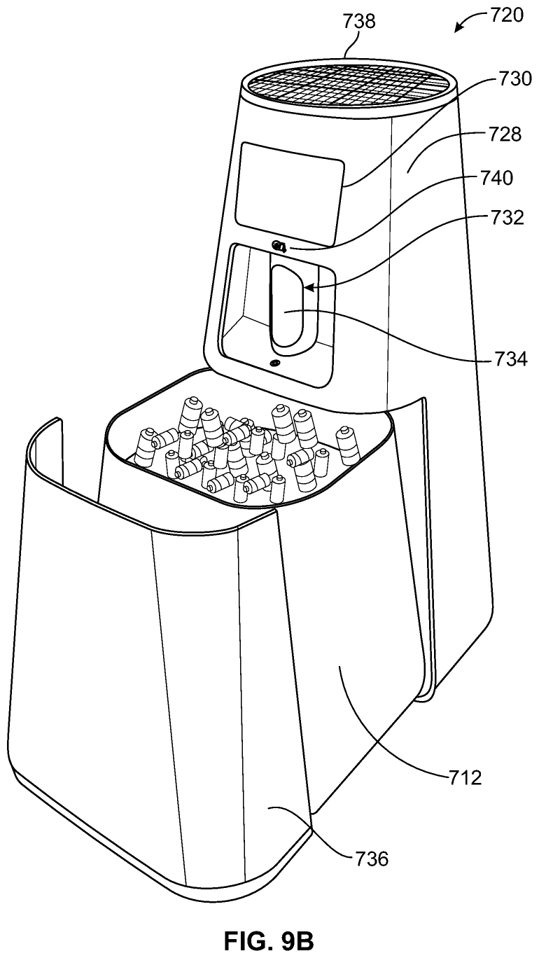

FIGS. 9A and 9B show an embodiment of another containment system according to the present disclosure (hereinafter, “containment system 720”). Specifically, FIG. 9A is a front elevational view of the containment system 720 in a closed configuration and FIG. 9B is a front perspective view of the containment system 720 in an open configuration. FIGS. 9A and 9B are referred to jointly herein. Containment system 720 can include similar functionality to the containment system 120, discussed in connection with FIG. 1, except for distinctions noted herein, or otherwise apparent to persons of ordinary skill in the art.

As shown, the containment system 720 includes a housing 728, a user interface device 730, an aperture 732 disposed through the housing 728 and configured to receive a piece of recyclable material 101 (e.g., a plastic bottle, glass bottle, aluminum can, etc.), a movable door 734 positioned over or within, and configured to prevent unauthorized access to, the aperture 732, an access door or tray 736 for providing access to a secondary containment bin 712 provided within an interior of the housing 728, one or more solar panels 738 for providing power to one or more electrical components of the containment system 720, and an NFC communication device 740, or other communications device heretofore known or developed, configured to communicate with a mobile device of a user 110 (e.g., consumer host device 106). According to some embodiments of the present disclosure, a user 110 can login to or access their user account on the user interface device 730 by moving a user host device 106 (e.g., running consumer application 128 and equipped with NFC technology) within proximity of the communication device 740, thereby unlocking the door 734, providing access to the aperture 734, and allowing the user 110 to deposit recyclable material 101 in the containment system 720.

Furthermore, as described, for example, in connection with FIG. 1, the containment system 720 can include one or more communication interfaces, providing for two-way (e.g., direct, network, serial, etc.) communication between the containment system 720 and one or more of a consumer host device 106, an admin host device 107, an enterprise host device 108, a processing system 105, another containment system (e.g., containment systems 120, 220, 320, etc. or otherwise disclosed herein), or other components or subsystems of the system 100.

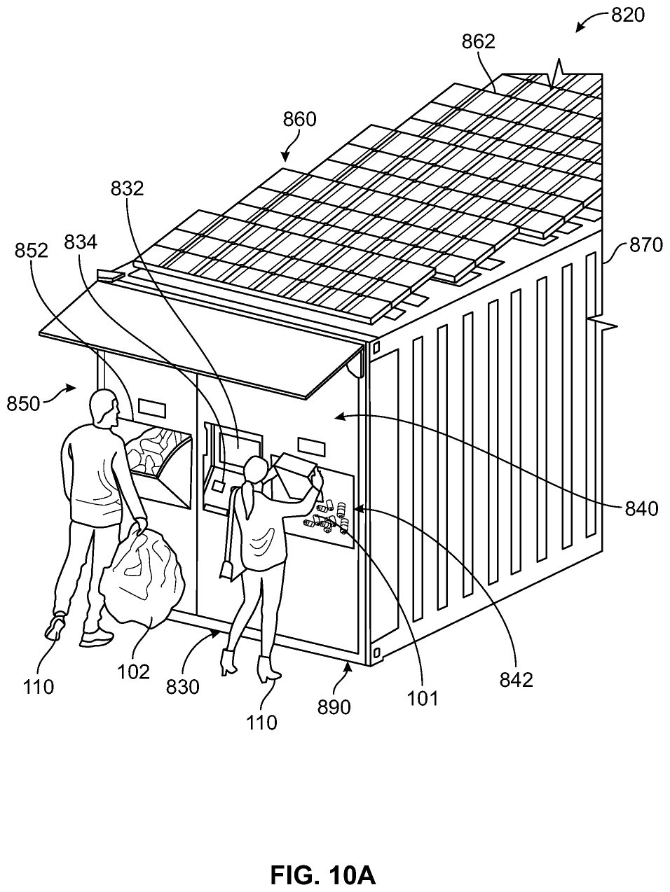

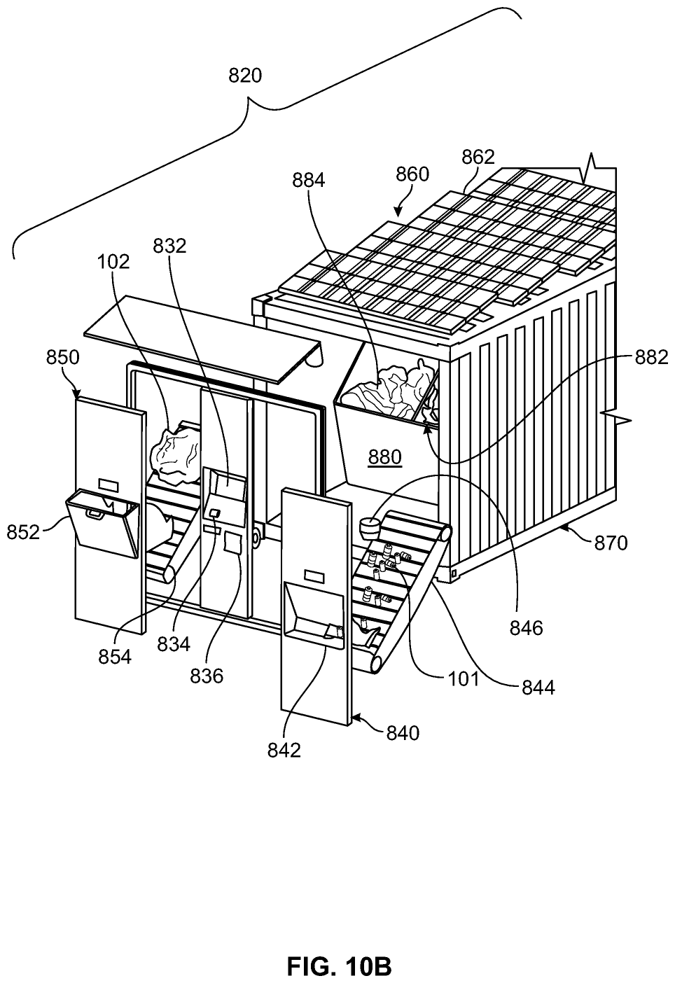

FIGS. 10A and 10B show an embodiment of another containment system according to the present disclosure (hereinafter, “containment system 820”), containment system 820 being configured for outdoor use. Specifically, FIG. 10A is a partial front perspective view of the containment system 820 and FIG. 10B is an exploded view of the containment system 820 of FIG. 10A. FIGS. 10A and 10B are referred to jointly herein. Containment system 820 can include similar functionality, systems, and subsystems as the containment system 120, discussed in connection with FIG. 1, except for distinctions noted herein, or otherwise apparent to persons of ordinary skill in the art.

The containment system 820 includes a user interface module 830, a first recyclable material receiving module 840 (hereinafter, “receiving module 840”), a second recyclable material receiving module 850 (hereinafter, “receiving module 850”), a power supply 860, a housing 870, and a secondary containment unit 880. The user interface module 830 includes a user interface device 832, a receipt printer 834, and a dispenser 836 configured to provide primary containment units 102.

The first receiving module 840 includes an aperture 842 (e.g., door, slot, hopper, etc.) configured to receive one or more individual items of recyclable material 101 from a user 110, a conveyor 844 (e.g., an incline conveyor) configured to receive the one or more individual items of recyclable material 101 from the aperture 842 and transport same to the secondary containment unit 880, and a vision system 846 configured to identify the one or more individual items of recyclable material 101 traveling on the conveyor 844.

The second receiving module 850 includes an aperture 852 (e.g., door, slot, hopper, etc.) configured to receive one or more primary containment units 102 having one or more individual items of recyclable material 101 therein, a conveyor 854 (e.g., an incline conveyor) configured to receive the one or more primary containment units 102 from the aperture 852 and transport same to the secondary containment unit 880. The second receiving module 850 can also include a vision system (not shown), or other systems disclosed herein, configured to identify ID tags 111 disposed on the one or more primary containment units 102 received by the aperture 852, or traveling on the conveyor 854.

As shown, the power supply 860 includes one or more solar panels 862. However, it is contemplated by the present disclosure that the power supply 860 can additionally, or alternatively, include one or more of a battery, an A/C input, or any other system for providing power to the electrical components of the containment system 820.

As shown, the housing 870 can comprise a shipping container, or other commonly utilized container for transporting goods (e.g., a trailer, a railroad container, or the like). According to the embodiment of FIGS. 10A and 10B, the user interface module 830, the first receiving module 840, and the second receiving module 850 could be configured to form a removable face 890 of the housing 870, such that access to the interior of the housing 870 is prevented when the user interface module 830, the first receiving module 840, and the second receiving module 850 are positioned as shown in FIG. 10A.

The secondary containment module 880 can be divided into a first area 882 for receiving the one or more items of recyclable material 101 from the conveyor 846 and a second area 884 for receiving the one or more secondary containment units 102 from the conveyor 856. Additionally, the secondary containment 880 can be configured to maximize internal space of the housing 870, thereby maximizing runtime of the containment system 820 and minimizing trips by internal transportation 104 to empty or retrieve the secondary containment unit 870, or the containment system 820.

Furthermore, as described, for example, in connection with FIG. 1, the containment system 820 can include one or more communication interfaces, providing for two-way (e.g., direct, network, serial, etc.) communication between the containment system 820 and one or more of a consumer host device 106, an admin host device 107, an enterprise host device 108, a processing system 105, another containment system (e.g., containment systems 120, 220, 320, etc. or otherwise disclosed herein), or other components or subsystems of the system 100.

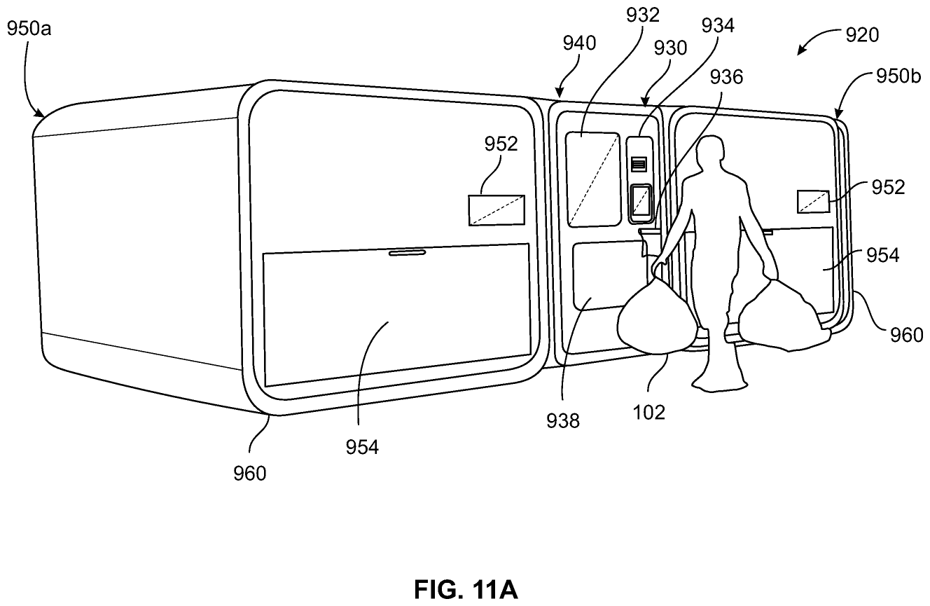

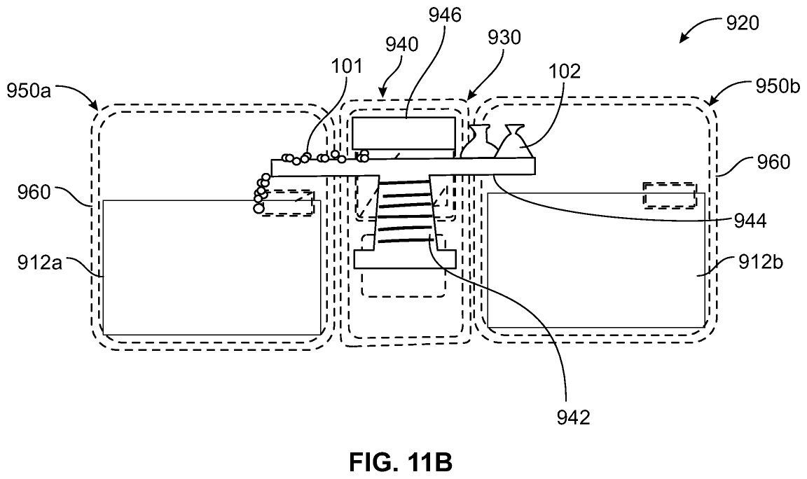

FIGS. 11A and 11B show an embodiment of another modular containment system according to the present disclosure (hereinafter, “containment system 820”), the containment system 920 being configured for indoor use. Specifically, FIG. 11A is a front perspective view of the containment system 920 and FIG. 11B is a diagram showing internal components of the containment system 920 of FIG. 11A. FIGS. 11A and 11B are referred to jointly herein. Containment system 920 can include similar functionality, systems, and subsystems as the containment systems 120 and 820, discussed in connection with FIGS. 1 and 10A and 10B respectively, except for distinctions noted herein, or otherwise apparent to persons of ordinary skill in the art.

The containment system 920 includes a user interface module 930, a first recyclable material collection module 950a (hereinafter, “collection module 950a”), a second recyclable material collection module 950b (hereinafter, “collection module 950b”) (together, “collection modules 950”). It should be understood that the collection modules 950 can be substantially similar in form and functionality. Furthermore, while both the first recyclable material collection module 950a and the second recyclable material collection module 950b are shown in connection with user interface module 930, it should be understood that the containment system 920 can include a fewer, or a greater, number of collection modules 950. For example, the containment system 920 can include only a single collection module 950 where only a single type of recyclable material 101 is being collected, or the containment system 920 can include a plurality of collection modules 950 where a plurality of types of recyclable material 101 are being collected by the containment system 920.

The user interface module 930 includes a user interface device 932, a payment unit 934, a dispenser 936 configured to provide primary containment units 102 to users 110, a hopper 938 for receiving one or more individual items of recyclable material 101 or primary containment units 102, and a housing 940.

Each of the collection modules 950 includes a diagnostic display 952 configured to display one or more metrics related to the collection unit 950 or the contents thereof, a service door 954 for accessing an interior of the collection module 950, and a housing 960.

As shown in FIG. 11B, an incline conveyor 942 is positioned within the user interface module 930 and is in communication with the hopper 938. The incline conveyor 942 is configured to transport recyclable material 101 or primary containment units 102 from the hopper 938 to a horizontal conveyor extending between interiors of the user interface module 930 and the collection modules 950. A sorting unit 946 positioned adjacent to the horizontal conveyor 944 identifies (e.g., using vision systems or other means described herein) recyclable material 101 and/or primary containment units 102 on the horizontal conveyor 944 and determines an appropriate location therefor. The horizontal conveyor 944 then transports the recyclable material 101 and/or primary containment units 102 to an appropriate collection module 950. For example, according to the embodiment of FIG. 11B, individual items of recyclable material 101 identified by the sorting system 946 is conveyed to a secondary containment unit 912a of the collection module 950a and/or primary containment units 102 identified by the sorting system 946 are conveyed to a secondary containment unit 912b of the collection module 950b.

Furthermore, as described, for example, in connection with FIG. 1, the containment system 920 can include one or more communication interfaces, providing for two-way (e.g., direct, network, serial, etc.) communication between the containment system 920 and one or more of a consumer host device 106, an admin host device 107, an enterprise host device 108, a processing system 105, another containment system (e.g., containment systems 120, 220, 320, etc. or otherwise disclosed herein), or other components or subsystems of the system 100.

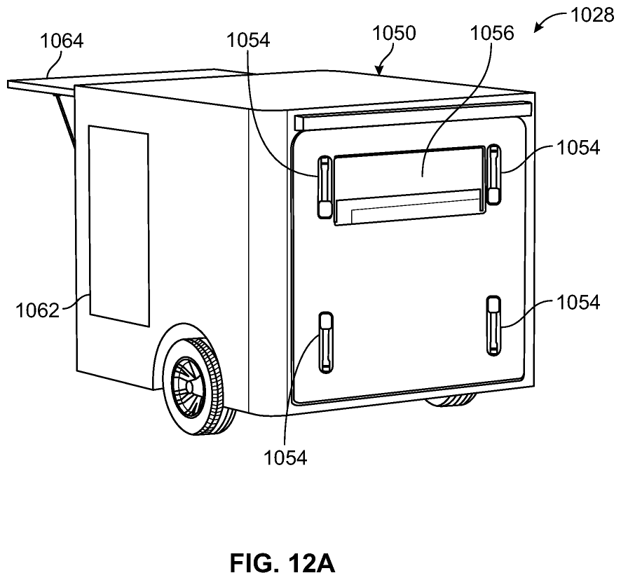

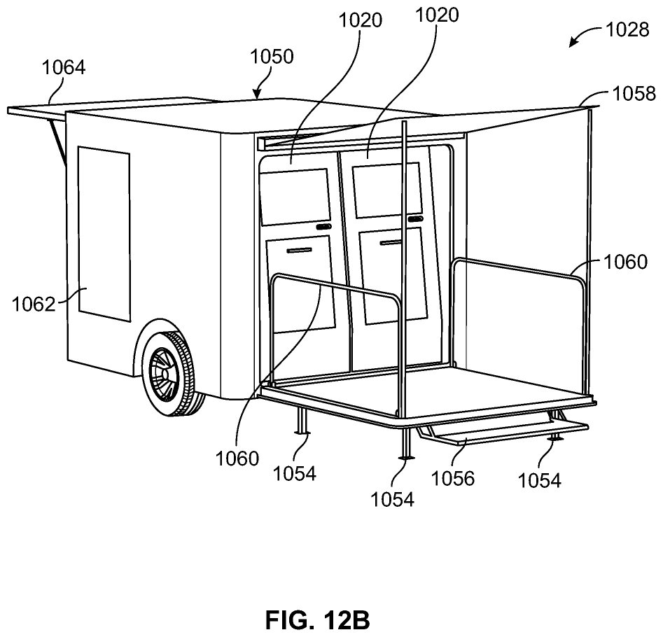

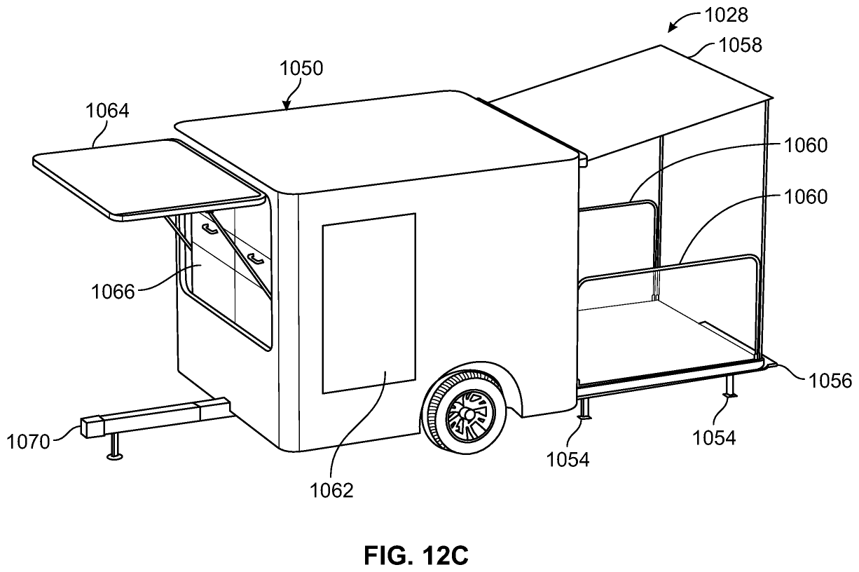

FIGS. 12A-C show an embodiment of a mobile processing system 1028 according to the present disclosure (hereinafter, “processing system 1028”). Specifically, FIG. 12A is a rear perspective view of the processing system 1028 positioned in a closed configuration, FIG. 12B is a rear perspective view of the processing system 1028 of FIG. 12A positioned in a deployed configuration, and FIG. 12C is a front perspective view of the processing system 1028 of FIG. 12A positioned in the deployed configuration. FIGS. 12A-C are referred to jointly herein. Processing system 1028 can include similar functionality, systems, and subsystems as the mobile processing system 128, discussed in connection with FIG. 1, except for distinctions noted herein, or otherwise apparent to persons of ordinary skill in the art.

The processing system 1028 can include a carrier 1050 housing one or more containment systems 1020. The one or more containment systems 1020 can each be substantially similar to the containment system 420, discussed in connection with FIGS. 6A-F.

The carrier 1050 can be configured as a trailer, or other transportation container. As such, the carrier 1050 can include a trailer hitch 1070, or other means for coupling the carrier to a vehicle (e.g., internal transportation 104). As shown in FIG. 12A, the carrier can be positioned in a closed configuration for transportation and, as shown in FIGS. 12B and 12C, can be positioned in a deployed configuration for use. The carrier 150 can include a deployable platform 1052 having one or more supports 1054, one or more deployable steps 1056, a collapsible awning 1058, and one or more safety railings 1060. A display device 1062 (e.g., a screen) can be provided on one or more sides of the carrier. Additionally, the carrier 1050 can include a collapsible door 1064 on a side of the carrier 1050 opposite the platform 150 for providing access to one or more storage units 1066, or for providing access to contents of the one or more containment systems 1020.

Furthermore, as described, for example, in connection with FIG. 1, the processing system 1028 can include one or more communication interfaces, providing for two-way (e.g., direct, network, serial, etc.) communication between the processing system 1028 and one or more of a consumer host device 106, an admin host device 107, an enterprise host device 108, a processing system 105, another containment system (e.g., containment systems 120, 220, 320, etc. or otherwise disclosed herein), or other components or subsystems of the system 100.

FIG. 13 is a diagram of a primary containment unit 102 having an ID tag 111 according to the present disclosure.

FIG. 14 is a perspective view of another containment unit 202 according to the present disclosure having an enclosure 204 configured to receive one or more of recyclable material 101 and/or primary containment units 102. The containment unit 202 can include a tracking tag or chip 206 including one or more passive tracking systems (e.g., a barcode, a QR code, an RFID chip, or the like) as described, for example, in connection with ID tag 111. The tracking chip 206 can also include active tracking and communication systems (e.g., GPS systems, Wi-Fi connectivity, cellular connectivity, etc.) and/or one or more sensors for determining when the containment unit 202 is full. Accordingly, the system 100 can automatically determine when the containment unit 202 is full, determine the location of the containment unit 202, and schedule internal transportation 104 to pick up the contents of the containment unit 202. Furthermore, the containment unit 202 can include a solar panel 208 or other power source disclosed herein (e.g., a rechargeable battery) for providing continuous power to the active tracking and communication systems of the container 202.

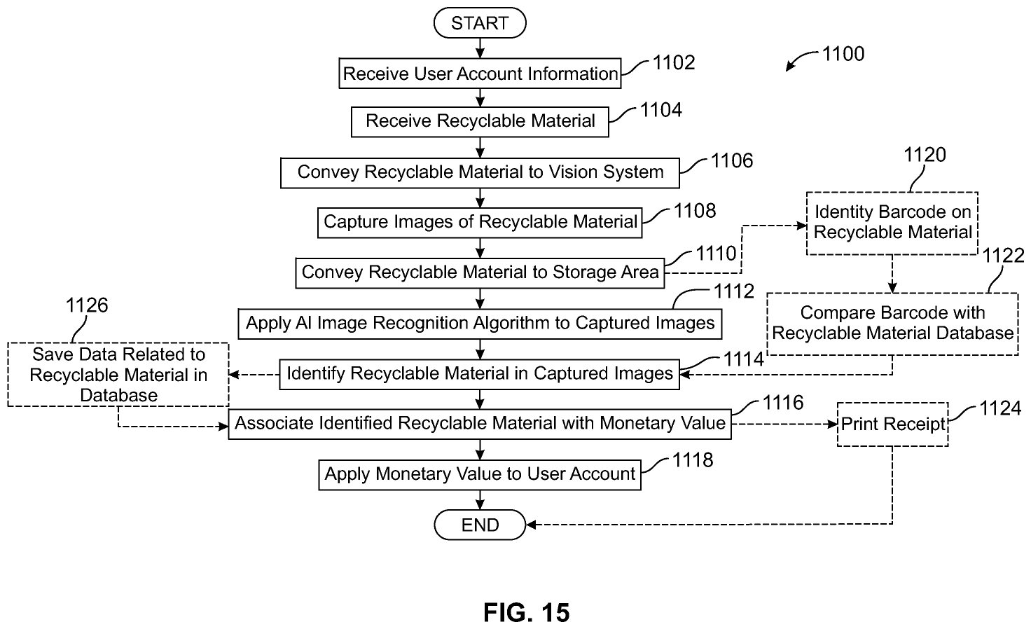

FIG. 15 is a diagram illustrating overall processing steps 1100 carried out by the system 100 of the present disclosure in connection with one or more of the hardware and software components disclosed herein, such as, for example, one or more of the containment systems (e.g., containment systems 120, 220, 320, 420, etc.), processing systems (e.g., processing systems 105, 128, 1028, etc.), and applications (e.g., consumer application 129, enterprise application 134, administrator application 142, etc.).

At step 1102, the system 100 receives user account information (e.g., via the consumer application 129 or user interface 130). At step 1104, the system 100 receives recyclable material 101 (e.g., via a containment system 120). At step 1106, the system 100 conveys the recyclable material to a vision system, or other data acquisition system disclosed herein. At step 1108, the system 100 captures one or more images of the recyclable material via the vision system, or other data acquisition system. At step 1110, the system 100 conveys the recyclable material to a storage area (e.g., secondary containment unit 112). At step 1112, the system applies an artificial intelligence (“AI”) algorithm to the one or more captured images. At step 1114, the system 1000 identifies the recyclable material shown in the one or more captured images (e.g., using the AI algorithm). Optionally, at step 1120, the system can identify one or more barcodes from the captured images of the recyclable material, and at step 1122, the system can compare the one or more barcodes with a recyclable material database in order to identify the recyclable material. Optionally, at step 1126, the system 100 can save data related to the identified recyclable material in a database for future retrieval and/or use.

The process then proceeds to step 1116, where the system 100 associates the identified recyclable material with a monetary value (e.g., based on a table stored in a local database, retrieved via the Internet, or the like). At step 118, the system 100 applies a monetary value to the user account received in step 1102, and then the process ends. Optionally, at step 1124, the system can print a receipt including the monetary value of the identified recyclable material. For example, the receipt can include a numeric code, barcode, QR code, voucher or other redemption means, such that a user can bring the receipt to a store or other location to receive a credit for the identified recyclable materials.

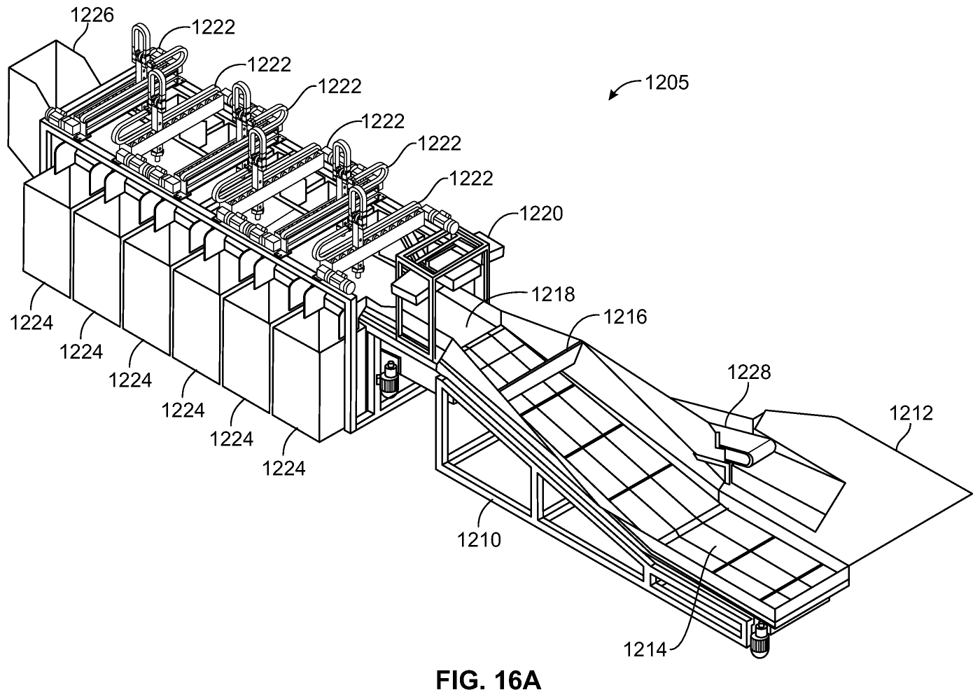

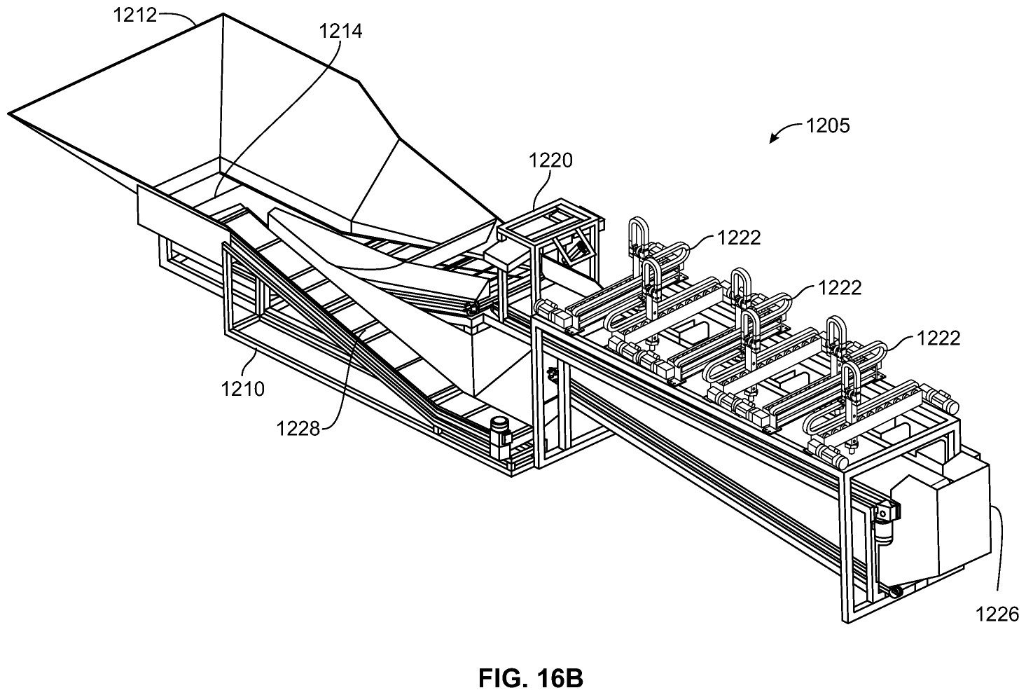

FIGS. 16A and 16B show an embodiment of a processing system according to the present disclosure (hereinafter, “processing system 1205”). Specifically, FIG. 16A is a front perspective view of the processing system 1205 and FIG. 16B is a rear perspective view of the processing system 1205 of FIG. 16A. FIGS. 16A and 16B are referred to jointly herein. Processing system 1205 can include similar functionality, systems, and subsystems as the processing system 105, discussed in connection with FIG. 1, except for distinctions noted herein, or otherwise apparent to persons of ordinary skill in the art.

Processing system 1205 includes a frame 1210 configured to support one or more of the components and/or subsystems of the processing system 1205, including a hopper 1212 for receiving recyclable material 101, a conveyor 1214 with a sweep brush 1216 configured to transport the recyclable material 101 to a sorting conveyor 1218, a vision system 1220 configured to identify individual items of the recyclable material 101, a plurality of robotic sorting devices 1222 (together, “sorting devices 1222”), such as, for example, cartesian devices, delta devices, 6-axis devices, or any other robotic devices heretofore known or developed, configured to deposit the recyclable material 101 into a plurality of containment units 1224, a return chute 1226 configured to receive unsorted recyclable material 101, and a return conveyor 1228 configured to receive the unsorted recyclable material 101 from the return chute 1228 and transport the unsorted recyclable material 101 back to the hopper 1212. According to embodiments of the present disclosure, each of the plurality of containment units 1224 corresponds to one or more (e.g., material) types of recyclable material 101, such that the sorting devices 1222 can deposit the recyclable material 101 identified by the vision system 1220 in one or more of the containment units 1224 of a corresponding type. Additionally, unidentified recyclable material 101 can be returned to the hopper 1212 for further processing.

Furthermore, as described, for example, in connection with FIG. 1, the processing system 1205 can include one or more communication interfaces, providing for two-way (e.g., direct, network, serial, etc.) communication between the processing system 1205 and one or more of a consumer host device 106, an admin host device 107, an enterprise host device 108, another processing system (e.g., processing system 105), a containment system (e.g., containment systems 120, 220, 320, etc.), or other components or subsystems of the system 100 disclosed herein.

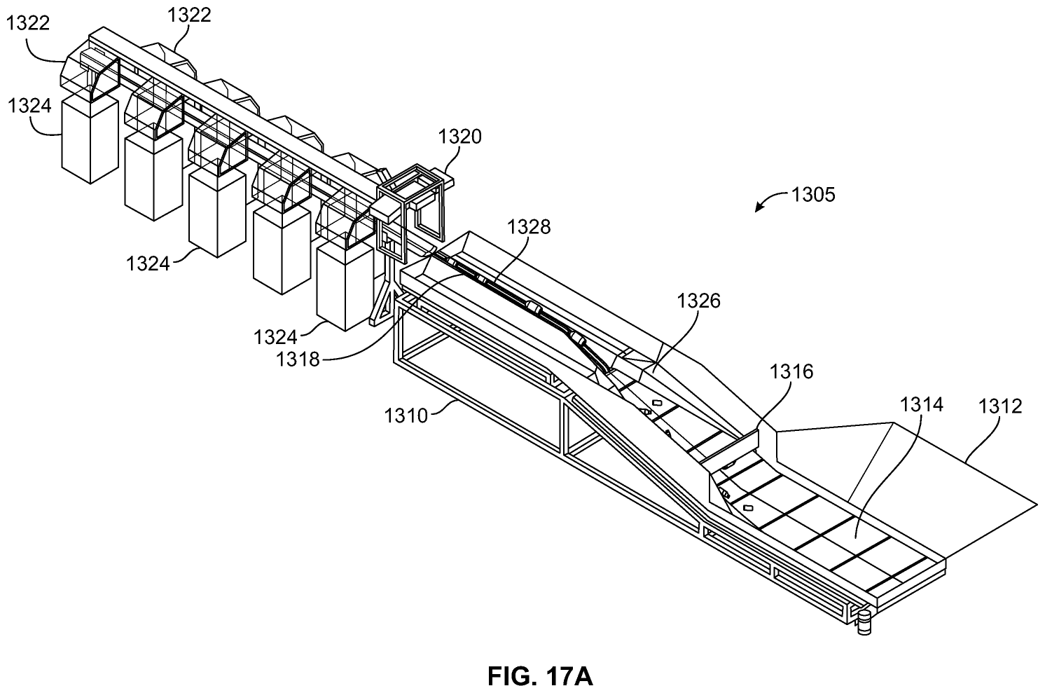

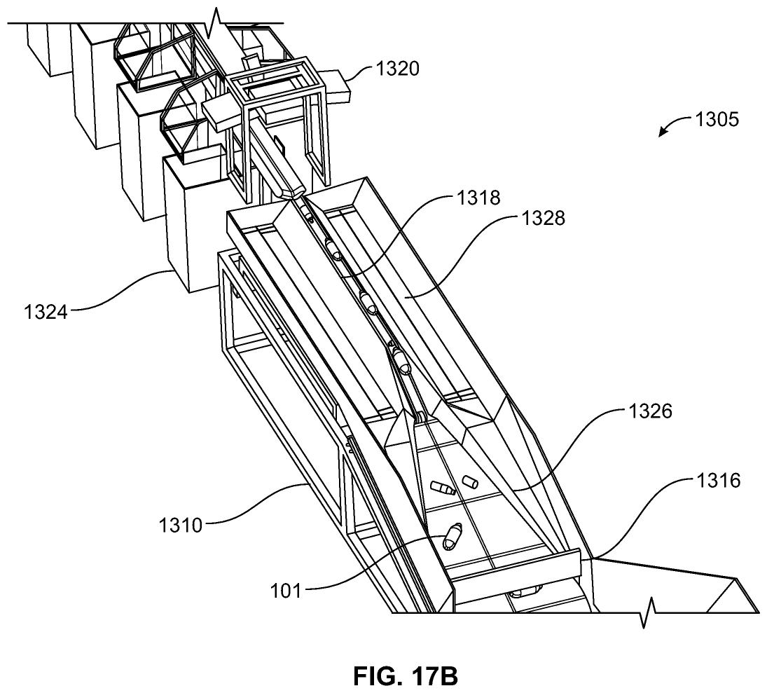

FIGS. 17A and 17B show another embodiment of a processing system according to the present disclosure (hereinafter, “processing system 1305”). Specifically, FIG. 17A is a front perspective view of the processing system 1305 and FIG. 17B is a partial perspective view of the processing system 1305 of FIG. 17A. FIGS. 17A and 17B are referred to jointly herein. Processing system 1305 can include similar functionality, systems, and subsystems as the processing system 105, discussed in connection with FIG. 1, except for distinctions noted herein, or otherwise apparent to persons of ordinary skill in the art.

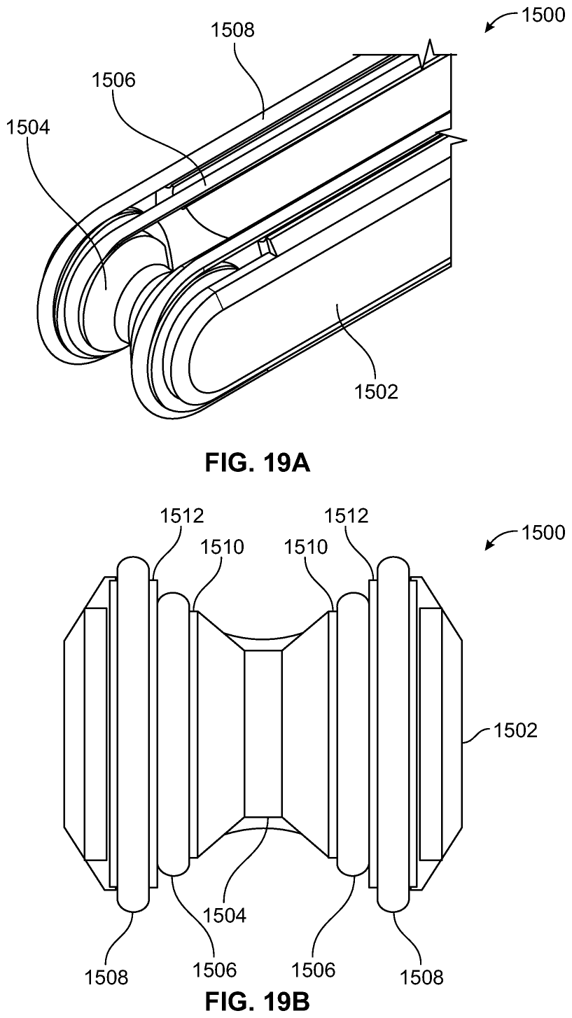

Processing system 1305 includes a frame 1310 configured to support one or more of the components and/or subsystems of the processing system 1305, including a hopper 1312 for receiving recyclable material 101, a conveyor 1314 with a sweep brush 1316 configured to transport the recyclable material 101 to a belt conveyor 1318 (e.g., the double round belt conveyor, shown and described in connection with FIGS. 19A and 19B, a single round belt conveyor, a V-shaped conveyor, a flat conveyor, etc.), a vision system 1320 configured to identify individual items of the recyclable material 101, and a plurality of sorter/separator devices 1322 (together, “separator devices 1322”) configured to deposit the recyclable material 101 into a plurality of containment units 1324.

As shown best in FIG. 17B, sheet metal guides 1326 are configured to receive unsorted recyclable material 101 from the conveyor 1314 and funnel the recyclable material 101 onto the belt conveyor 1318 in a single profile. One or more return conveyors 1328 are positioned along either side of the belt conveyor 1318 and are configured to receive recyclable material 101 not received by the belt conveyor 1318 and transport the recyclable material 101 back to the hopper 1312 for further processing.

According to embodiments of the present disclosure, each of the plurality of containment units 1324 corresponds to one or more (e.g., material) types of recyclable material 101, such that the devices 1322 can deposit the recyclable material 101 identified by the vision system 1320 in one or more of the containment units 1324 of a corresponding type. According to some embodiments of the present disclosure, the devices 1322 can comprise pneumatic pressurized air nozzles arranged along the belt conveyor 1318, such that identified items of recyclable material 101 can be ejected from the belt conveyor 1318 (e.g., by way of a pressurized air stream directed from devices 1322) and received by an adjacent containment unit 1324 of a corresponding type. According to further embodiments of the present disclosure, the devices 1322 can comprise flaps, guides, magnetic elements, eddy-current detection systems, or other sorting systems heretofore known or developed.

Furthermore, as described, for example, in connection with FIG. 1, the processing system 1305 can include one or more communication interfaces, providing for two-way (e.g., direct, network, serial, etc.) communication between the processing system 1305 and one or more of a consumer host device 106, an admin host device 107, an enterprise host device 108, another processing system (e.g., processing system 105), a containment system (e.g., containment systems 120, 220, 320, etc.), or other components or subsystems of the system 100 disclosed herein.

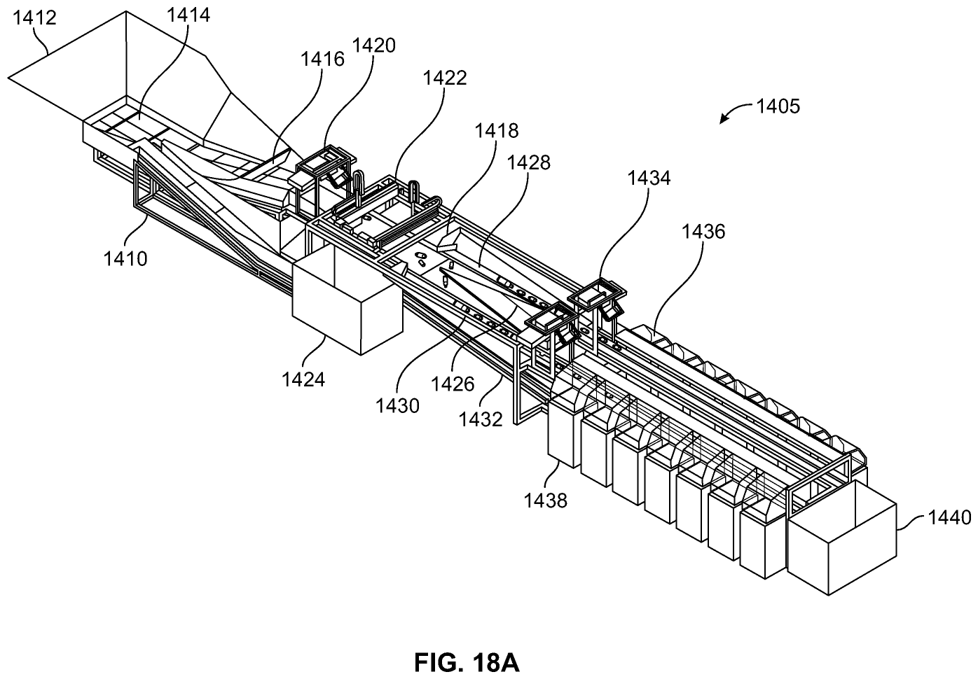

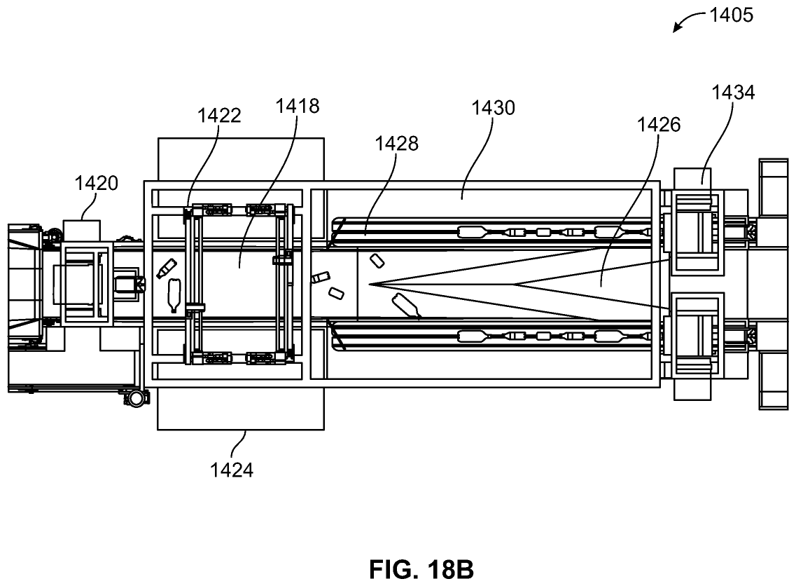

FIGS. 18A and 18B show another embodiment of a processing system according to the present disclosure (hereinafter, “processing system 1405”). Specifically, FIG. 18A is a rear perspective view of the processing system 1405 and FIG. 18B is a top view of the processing system 1405 of FIG. 18A. FIGS. 18A and 18B are referred to jointly herein. Processing system 1405 can include similar functionality, systems, and subsystems as the processing system 105, discussed in connection with FIG. 1, except for distinctions noted herein, or otherwise apparent to persons of ordinary skill in the art.

Processing system 1405 includes a frame 1410 configured to support one or more of the components and/or subsystems of the processing system 1405, including a hopper 1412 for receiving recyclable material 101, a conveyor 1414 with a sweep brush 1416 configured to transport the recyclable material 101 to a main conveyor 1418, a primary vision system 1420 configured to identify contaminated items of the recyclable material 101, one or more cartesian robot sorting devices 1422 (together, “sorting devices 1422”) configured to extract the contaminated recyclable material 101 from the conveyor 1418 and deposit the contaminated recyclable material 101 into one or more contaminated material bins 1224, a V-shaped guide 1426 configured to direct the recyclable material 101 from the main conveyor 1418 into one or more belt conveyors 1428 (e.g., double round belt conveyors, shown and described in connection with FIGS. 19A and 19B, single round belt conveyors, V-shaped conveyors, flat conveyors, etc.) in a single profile, one or more overflow hoppers 1430 configured to receive recyclable material 101 that is not diverted into the one or more belt conveyors 1428, a return conveyor system 1432 configured to receive the recyclable material 101 from the overflow hopper 1430 and return the recyclable material 101 to the main hopper 1412, a sorting vision system 1434 configured to identify individual items of the recyclable material 101, a plurality of sorter/separator devices 1436 (together, “separator devices 1436”) configured to deposit the recyclable material 101 into one or more of a plurality of sorted material containment units 1438, and one or more unsorted material containment units 1440.

Ash shown best in FIG. 18B, the V-shaped guide 1426 is configured to divert the recyclable material 101 from the main conveyor 1418 and direct the recyclable material 101 onto the one or more belt conveyors 1428 in a single profile. The one or more overflow hoppers 1430 are positioned along the one or more belt conveyors 1428 and are configured to receive recyclable material 101 not received by the one or more belt conveyors 1428. The one or more hoppers 1430 are in communication with the return conveyor system 1432, such that the recyclable material 101 can be transported back to the main hopper 1412 for further processing.

According to embodiments of the present disclosure, each of the plurality of containment units 1438 corresponds to one or more (e.g., material) types of recyclable material 101, such that the devices 1436 can deposit the recyclable material 101 identified by the vision system 1434 in one or more of the containment units 1436 of a corresponding type. According to some embodiments of the present disclosure, the devices 1436 can comprise pressurized air nozzles arranged along the one or more belt conveyors 1428, such that identified items of recyclable material 101 can be ejected from the one or more belt conveyors 1428 (e.g., by way of a pressurized air stream from devices 1436) and received by an adjacent containment unit 1438 of a corresponding type. According to further embodiments of the present disclosure, the devices 1436 can comprise flaps, guides, magnetic elements, eddy-current detection systems, or other sorting systems heretofore known or developed.

Furthermore, as described, for example, in connection with FIG. 1, the processing system 1405 can include one or more communication interfaces, providing for two-way (e.g., direct, network, serial, etc.) communication between the processing system 1405 and one or more of a consumer host device 106, an admin host device 107, an enterprise host device 108, another processing system (e.g., processing system 105), a containment system (e.g., containment systems 120, 220, 320, etc.), or other components or subsystems of the system 100 disclosed herein.

FIGS. 19A and 19B show an embodiment of a double round belt conveyor according to the present disclosure (hereinafter, “belt conveyor 1500”). Specifically, FIG. 19A is a partial perspective view of the belt conveyor 1500 and FIG. 19B is a front view of the belt conveyor 1500 of FIG. 19A. FIGS. 19A and 19B are referred to jointly herein.

The belt conveyor 1500 includes a frame 1502 supporting one or more pulleys 1504 having a stepped profile configured to receive inner belts 1506 and outer belts 1508. According to some embodiments of the present disclosure, the pulley 1504 can have inner annular steps 1510 for receiving the inner belts 1506 and outer annular steps 1512 for receiving the outer belts 1508. According to such embodiments, the conveyor 1500 can receive a first item of recyclable material 101 having a first diameter on the inner belts 1506 and the conveyor 1500 can receive a second item of recyclable material having a second diameter on the outer belts 1506, where the second diameter is greater than the first diameter.

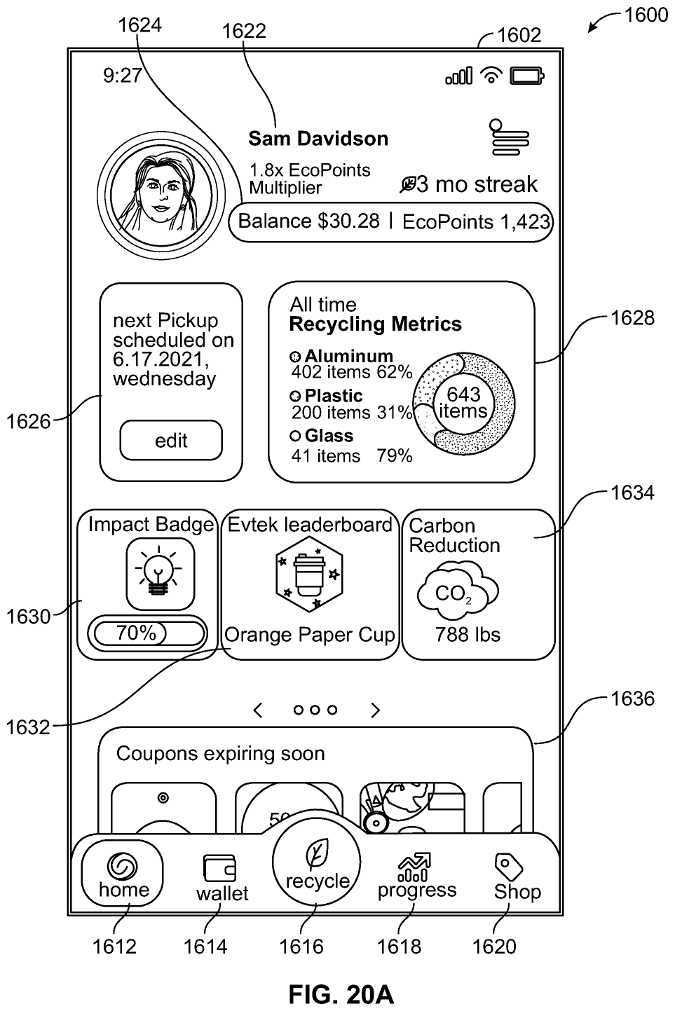

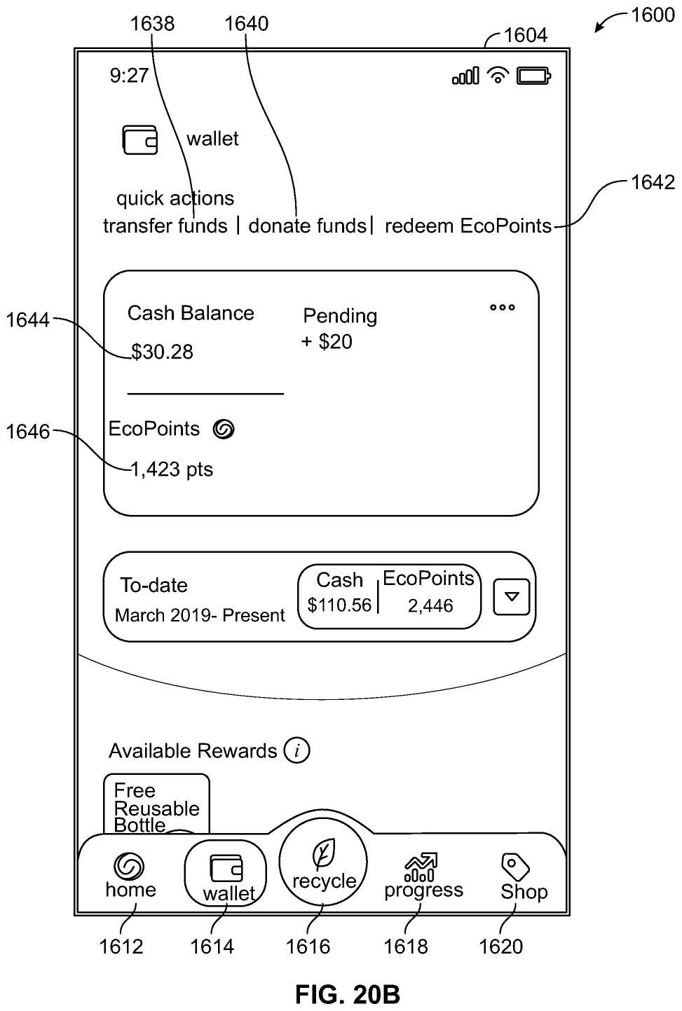

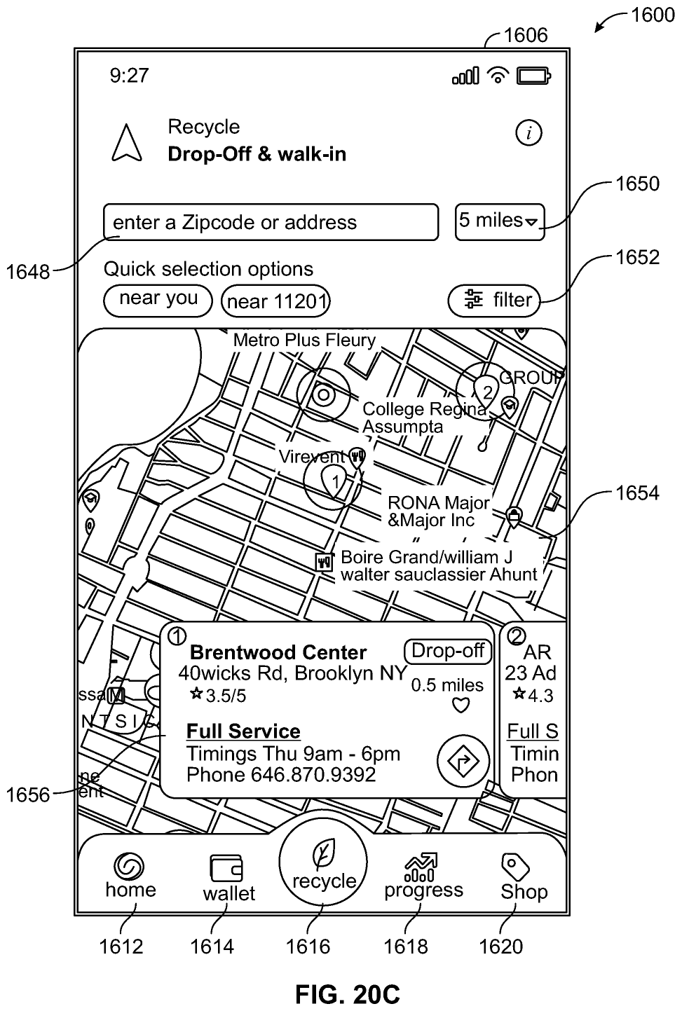

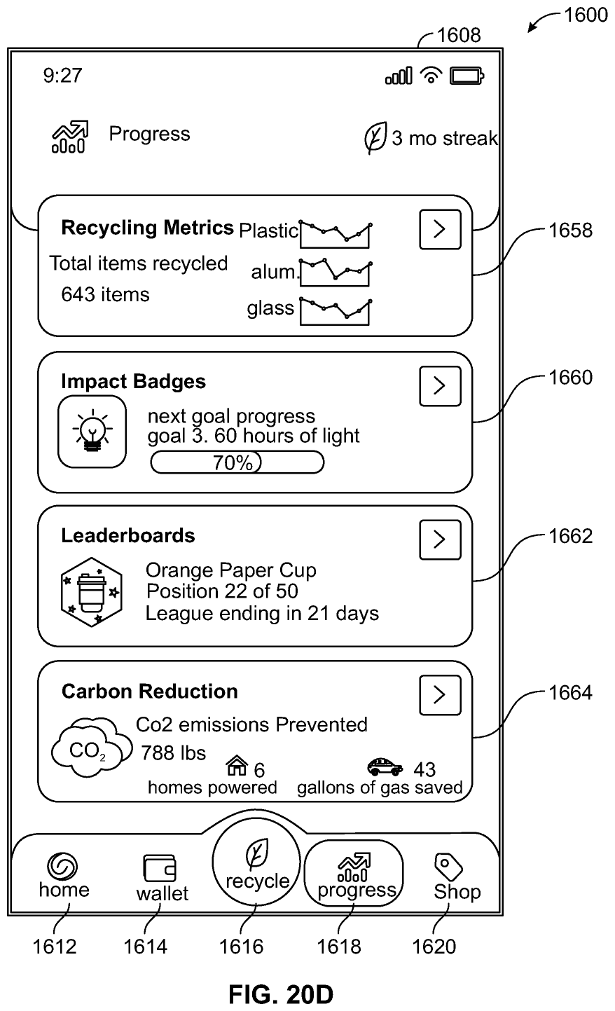

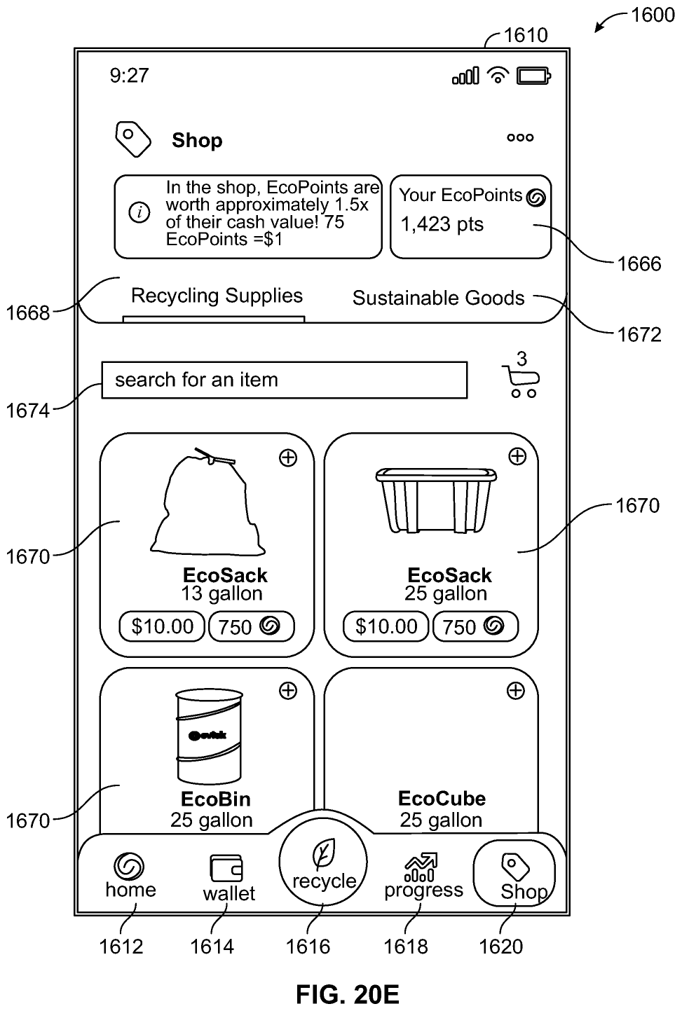

FIGS. 20A-E show a graphical user interface generated by the system 100 the present disclosure (hereinafter, “user interface 1600”). Specifically, FIG. 20A is a graphical user interface home page 1602 (hereinafter, “home page 1602”), FIG. 20B is a graphical user interface wallet page 1604 (hereinafter, “wallet page 1604”), FIG. 20C is a graphical user interface recycle page 1606 (hereinafter, “recycle page 1606”), FIG. 20D is a graphical user interface progress page 1608 (hereinafter, “progress page 1608”), and FIG. 20E is a graphical user interface shop page 1610 (hereinafter, “shop page 1610”). It should be understood that the user interface 1600 can be generated by the consumer application 129, executed by the consumer host device 106. Accordingly, user interface 1600 can include similar functionality, systems, and subsystems of the consumer application 129, discussed in connection with FIG. 1, except for distinctions noted herein, or otherwise apparent to persons of ordinary skill in the art.

The user interface 1600 can include a plurality of user interface elements 1612-1620 corresponding to the home page 1602, the wallet page 1604, the recycle page 1606, the progress page 1608, and the shop page 1610 respectively. For example, touching (e.g., pressing on, clicking on, actuating, or otherwise selecting) user interface element 1612 will cause the user interface 1600 to display the home page 1602, touching user interface element 1614 will cause the user interface 1600 to display the wallet page 1604, touching user interface element 1616 will cause the user interface 1600 to display the recycle page 1606, touching user interface element 1618 will cause the user interface 1600 to display the progress page 1608, and touching user interface element 1620 will cause the user interface 1600 to display the shop page 1610.

The home page 1602 can include a plurality of user interface elements displaying information, providing access to information (e.g., hyperlinks to another graphical user interface page), or providing functionality, such as, but not limited to, displaying an account name 1622, displaying an account balance 1624, displaying scheduled recycling pickups 1626, displaying recycling metrics 1628, displaying milestone badges 1630, providing access to leaderboards 1632, and displaying offers 1636.

The wallet page 1604 can include a plurality of user interface elements displaying information, providing access to information (e.g., hyperlinks to another graphical user interface page), or providing functionality, such as, but not limited to, transferring funds 1638, donating funds 1640, redeeming points 1642, displaying an account balance 1644, and displaying earned points 1646.

The recycling page 1606 can include a plurality of user interface elements displaying information, providing access to information (e.g., hyperlinks to another graphical user interface page), or providing functionality related to scheduling recycling pick-up and/or locating recycling locations, such as, but not limited to, a search field 648, a drop-down menu 650 for selecting a search radius, a filter 652 for filtering search results, a map 654 for displaying one or more recycling locations in a given area, and information regarding one or more recycling locations 656.

The progress page 1608 can include a plurality of user interface elements displaying information, providing access to information (e.g., hyperlinks to another graphical user interface page), or providing functionality related to a user's progress or recycling history, such as, but not limited to, recycling metrics 1658, progress badges and goals 1660, leaderboards, 1662, and carbon reduction information 1664.

The shop page 1610 can include a plurality of user interface elements displaying information, providing access to information (e.g., hyperlinks to another graphical user interface page), or providing functionality related to acquiring recycling supplies and/or sustainable goods, such as, but not limited to, a points balance 1666, a selection tab 1668 for displaying one or more recycling supplies 1670 (e.g., recycling bags, crates, bins, etc.) available for purchase or redemption, a selection tab 1672 for displaying one or more sustainable goods available for purchase or redemption, and a search field for searching for items available for purchase or redemption.

Having thus described the systems and methods in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure.

What is claimed is:

1. A recycling system, comprising:
a controller;
a communications interface;
a user interface device configured to receive user identification information;
a housing having a first aperture for receiving recyclable material;
an identification system configured to identify the recyclable material;
wherein the controller retrieves a user account via the communications interface based on the user identification information;
wherein the controller assigns a value to identified recyclable material; and
wherein the controller associates the value with the user account.

2. The system of claim 1, wherein the value is a monetary value and the controller associates the monetary value with the user account.

3. The system of claim 1, comprising a printer configured to generate a receipt with the value assigned to the identified recyclable material.

4. The system of claim 1, wherein the identification system is an AI vision system configured to identify one or more of a material and a type of the recyclable material.

5. The system of claim 1, comprising a conveyor system configured to transport the recyclable material from the first aperture to a containment unit.

6. The system of claim 1, wherein the identification system is configured to identify an ID tag on a primary containment unit containing recyclable material and the controller associates the ID tag with the user account.

7. The system of claim 6, comprising a second aperture configured to receive a primary containment unit and wherein the first aperture is configured to receive individual items of recyclable material.

8. The system of claim 7, comprising a containment unit having a first area for storing one or more primary containment units and a second area for storing one or more individual items of recyclable material.

9. The system of claim 7, wherein the identification system comprises a sorting system configured to transport one or more individual items of recyclable material to a first storage unit and one or more primary containment units to a second storage unit.

10. The system of claim 1, wherein the controller monitors an amount of processed recyclable material and communicates the amount of processed material to a web-based server via the communications interface.

11. The system of claim 1, wherein the housing is configured to be moved from a first location to a second location via a transportation vehicle.

12. the system of claim 11, wherein the housing is disposed within a trailer, the trailer including a hitch for coupling the trailer to the transportation vehicle.

13. A recycling system, comprising:
a hopper for receiving recyclable material;
a vision system configured to identify one or more types of the recyclable material;
one or more containment units corresponding to the one or more types of the recyclable material;
a sorting system configured to place an item of recyclable material in one or more of the containment units corresponding to an identified type of the item of recyclable material; and
a conveyor system configured to transport the recyclable material from the hopper to the sorting system.

14. The system of claim 13, comprising a return conveyor system for transporting unidentified recyclable material from the sorting system to the hopper for further processing.

15. The system of claim 13, wherein the sorting system comprises one or more robotic sorting devices.

16. The system of claim 13, wherein the sorting system comprises one or more stationary sorting devices disposed along a length of the conveyor configured to remove the recyclable material from the conveyor system.

17. The system of claim 16, comprising a guide configured to divert the recyclable material into one or more single profile conveyors of the conveyor system.

18. The system of claim 17, comprising a vision system configured to identify contaminated items of the recyclable material.

19. The system of claim 18, comprising a sorting system configured to place a contaminated item of recyclable material in one or more containment units corresponding to contaminated material.

20. A method for recycling, comprising the steps of:
receiving user identification information from a user interface device;
receiving recyclable material;
processing the recyclable material with a vision system;
identifying a type of the recyclable material;
assigning a monetary value to the recyclable material based on the identified type of the recyclable material;
transmitting the user identification information and the monetary value of the recyclable material to a web-based server via a communications interface;
identifying a user account associated with user identification information; and
associating the monetary value of the recyclable material with the user account.
